(19) United States
(12) Patent Application Publication
(10) Pub. No.: US 2018/0075546 A1
(43) Pub. Date: Mar. 15, 2018

(54) SYSTEMS FOR DETERMINING AGRONOMIC OUTPUTS FOR A FARMABLE REGION, AND RELATED METHODS AND APPARATUS

(71) Applicant: CIBO Technologies, Inc., Cambridge, MA (US)

(72) Inventor: Ryan Richt, St. Louis, MO (US)

(21) Appl. No.: 15/701,353

(22) Filed: Sep. 11, 2017

Related U.S. Application Data
(60) Provisional application No. 62/385,897, filed on Sep. 9, 2016.

(51) Int. Cl. G06Q 50/02; G06F 17/50; G06Q 30/02; G06Q 10/04; G06Q 40/08; G06Q 10/06; G06T 1/00

(52) U.S. Cl. CPC G06Q 50/02; G06F 17/5009; G06Q 30/0202; G06Q 10/04; G06T 2207/30192; G06Q 10/06375; G06T 1/0007; G06T 2207/30188; G06Q 40/08

(57) ABSTRACT

A method may include obtaining data indicative of multiple agronomic scenarios, the data for each agronomic scenario including a hypothetical value for each of one or more agronomic inputs, in which the data for each of the agronomic scenarios is distinct from the data for each other one of the agronomic scenarios. The method may further include, for each of the multiple agronomic scenarios: predicting a predicted value for an agronomic output of a farmable region based on (i) the hypothetical value for each of the one or more agronomic inputs for the agronomic scenario and (ii) a measured value for each of at least one agronomic input of the farmable region. The method may further include generating a distribution of the predicted values for the agronomic output across the multiple agronomic scenarios.

### CROSS-REFERENCE TO RELATED APPLICATION(S)

This application claims priority to and the benefit of U.S. Provisional Patent Application Ser. No. 62/385,897, filed on Sep. 9, 2016, which is hereby incorporated by reference herein to the maximum extent permitted by applicable law.

### BACKGROUND

Agronomy is the science and technology of producing and using plants for food, fuel, fiber, ornamentation and land reclamation. Agronomy encompasses work in the areas of plant genetics, plant physiology, meteorology, and soil science.

### SUMMARY

In general, one innovative aspect of the subject matter described in this specification can be embodied in a method including: obtaining data indicative of multiple agronomic scenarios, the data for each agronomic scenario including a hypothetical value for each of one or more agronomic inputs, in which the data for each of the agronomic scenarios is distinct from the data for each other one of the agronomic scenarios; for each of the multiple agronomic scenarios: predicting a predicted value for an agronomic output of a farmable region based on (i) the hypothetical value for each of the one or more agronomic inputs for the agronomic scenario and (ii) a measured value for each of at least one agronomic input of the farmable region; and generating a distribution of the predicted values for the agronomic output across the multiple agronomic scenarios.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The actions of the method may include generating the hypothetical values for at least one of the multiple agronomic scenarios.

The actions of the method may include determining a commercially relevant characterization of the farmable region based on the distribution of the predicted values for the agronomic output across the multiple agronomic scenarios.

Determining the commercially relevant characterization may include determining a characterization of risk associated with the farmable region.

The actions of the method may include determining the characterization of risk based on a standard deviation of the distribution of the predicted values for the agronomic output.

The actions of the method may include enabling determination of an insurance policy for the farmable region based on the characterization of risk associated with the farmable region.

The actions of the method may include assigning the farmable region to an insurance category based on the characterization of risk associated with the farmable region, and in which the determination of the insurance policy is based on the insurance category.

The actions of the method may include identifying one of the predicted values for the agronomic output as a desired value; and determining a commercially relevant characterization of the farmable region based on the desired value for the agronomic output.

Determining the commercially relevant characterization may include determining one or more of an expected profit associated with the farmable region, a net present value of the farmable region, and a valuation of the farmable region.

Determining the commercially relevant characterization may include identifying a value for each of one or more agronomic inputs that, when applied to the farmable region, cause a value close to the desired value for the agronomic output to be achieved.

The value close to the desired value for the agronomic output may be a value within 10% of the desired value.

Identifying one of the predicted values as a desired value may include identifying the maximum or minimum predicted value as the desired value.

The actions of the method may include obtaining a measured value for each of the one or more agronomic inputs of each of multiple farmable regions; for each of the multiple agronomic scenarios and for each of the multiple farmable regions: predicting a value for the agronomic output of the farmable region based on (i) the hypothetical value for each of the one or more agronomic inputs for the agronomic scenario and (ii) the measured value for each of the one or more agronomic inputs of the farmable region; and determining a derived predicted value for the agronomic output for the multiple farmable regions for each of the multiple agronomic scenarios.

The actions of the method may include determining a commercially relevant characterization of the multiple farmable regions based on the derived predicted value for the agronomic output.

The agronomic output may include a crop yield, and determining the derived predicted value may include determining a total predicted crop yield for the multiple farmable regions.

Determining the commercially relevant characterization may include determining a commodity forecast based on the predicted total crop yield.

Determining the commercially relevant characterization may include determining an indication of financial value associated with the farmable region.

The actions of the method may include determining a net present value (NPV) associated with the farmable region based on the indication of financial value.

The actions of the method may include determining a change in a value for each of one or more agronomic inputs that cause the NPV associated with the farmable region to increase.

Predicting the predicted value for the agronomic output may include operating an agronomic simulator.

The agronomic simulator may have previously been calibrated based on one or more measured agronomic inputs or one or more measured agronomic outputs of the farmable region.

Predicting the predicted value for the agronomic output may include predicting the predicted value for the agronomic output based on data indicative of weed growth in the farmable region.

Predicting the predicted value for the agronomic output may include predicting the value for the agronomic output based on data indicative of plant hypoxia in the farmable region.

Predicting the predicted value for the agronomic output may include predicting the value for the agronomic output based on data indicative of insect activity in the farmable region.

Predicting the predicted value for the agronomic output may include predicting the value for the agronomic output based on data indicative of disease in the farmable region.

Predicting the predicted value for the agronomic output may include predicting the predicted value for the agronomic output based on data indicative of a plant growth cycle for plants in the farmable region.

In general, another innovative aspect of the subject matter described in this specification can be embodied in a method including: obtaining a predicted value for an agronomic output of a farmable region for each of multiple agronomic scenarios, each agronomic scenario associated with data including a hypothetical value for each of one or more agronomic inputs, in which the data for each of the agronomic scenarios is distinct from the data for each other one of the agronomic scenarios; and identifying a desired predicted value for the agronomic output across the multiple agronomic scenarios.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. Identifying the desired predicted value for the agronomic output may include identifying a maximum predicted value.

The agronomic output may include a crop yield and the desired predicted value may include a maximum predicted crop yield.

The actions of the method may include identifying the desired predicted value for the agronomic output subject to one or more constraints.

The agronomic output may include a crop yield and the one or more constraints may include a maximization of a financial value associated with the farmable region.

The financial value may be based on a combination of one or more of a cost associated with the farmable region, a revenue associated with the farmable region, and a risk associated with the farmable region.

The actions of the method may include identifying a value for each of one or more of the agronomic inputs that, when applied to the farmable region, causes a value close to the desired predicted value for the agronomic output to be achieved.

The value close to the desired predicted value for the agronomic output may be a value within 10% of the desired predicted value.

Identifying the value for each of the one or more of the agronomic inputs may include identifying one or more agronomic inputs that are responsive to intervention by a farm agent.

The actions of the method may include outputting, to a farm agent, a recommendation indicative of the identified value for each of the one or more agronomic inputs.

The actions of the method may include comparing the desired predicted value for the agronomic output to one or more historical values for the agronomic output for the farmable region.

The actions of the method may include generating an assessment of a farm agent for the farmable region based on the comparison.

The actions of the method may include enabling determination of an insurance policy for the farmable region or for a farm agent associated with the farmable region based on the comparison.

Enabling determination of the insurance policy may include one or more of enabling determination of whether to issue the insurance policy, enabling determination of a price of the insurance policy, and enabling determination of a risk associated with the insurance policy.

The actions of the method may include enabling determination of an insurance policy for the farm agent based on a comparison for each of multiple farmable regions.

The actions of the method may include determining an indication of financial value associated with the farmable region based on the desired predicted value for the agronomic output.

The actions of the method may include determining a valuation of the farmable region based on a net present value for the farmable region.

The actions of the method may include operating an agronomic simulator to obtain the predicted value for the agronomic output for each of the multiple agronomic scenarios.

The actions of the method may include generating the hypothetical value for each of the one or more agronomic inputs for at least one of the multiple agronomic scenarios.

In general, another innovative aspect of the subject matter described in this specification can be embodied in a method including: storing data indicative of correlations among multiple environmental characteristics; obtaining a first value for each of the multiple environmental characteristics for a first time period; and determining a second value for each of the multiple environmental characteristics for a second time period following the first time period based on the first value for each environmental characteristic and the data indicative of correlations among the multiple environmental characteristics.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The environmental characteristics may include one or more of precipitation amounts, temperature, solar radiation amounts, and humidity.

The actions of the method may include adjusting the data indicative of correlations among the environmental characteristics based on data indicative of seasonal environmental characteristics.

The actions of the method may include adjusting the data indicative of correlations among the environmental characteristics based on data indicative of weather volatility.

Storing the data indicative of correlations may include storing the data in a multidimensional data structure, each dimension of the data structure corresponding to a respective one of the multiple environmental characteristics.

Obtaining the first value for each environmental characteristic for the first time period may include obtaining a measured value for each environmental characteristic.

The actions of the method may include predicting a value for an agronomic output of a farmable region based on the second value for each environmental characteristic.

The second time period may occur within a specified amount of time after the first time period.

The second time period may immediately follows the first time period.

An environmental scenario for a particular time period may include a value for each of the environmental characteristics, and the actions of the method may include determining multiple environmental scenarios for the second time period based on the first value for each environmental characteristic and the data indicative of correlations among the environmental characteristics.

The actions of the method may include predicting multiple values for an agronomic output of a farmable region, the predicting of each of the multiple values based on the second values for a corresponding one of the multiple environmental scenarios.

The actions of the method may include determining a commodity forecast based on the predicted values for the agronomic output.

In general, another innovative aspect of the subject matter described in this specification can be embodied in a method including: obtaining data indicative of a measured value for an agronomic output of a farmable region for a period of time and a measured value for each of one or more agronomic inputs of the farmable region for the period of time; determining a hypothetical value for the agronomic output of the farmable region for the period of time, the hypothetical value for the agronomic output associated with a hypothetical value for each of the one or more agronomic inputs; identifying one or more of the agronomic inputs for which the measured value for the agronomic input differs from the hypothetical value for the agronomic input; and generating data for a graphical representation of the hypothetical value for the agronomic output, the measured value for the agronomic output, and the identified agronomic inputs.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. Determining the hypothetical value for the agronomic output of the farmable region may include: obtaining data indicative of a predicted value for the agronomic output of the farmable region for each of multiple agronomic scenarios, in which each agronomic scenario is associated with data including a hypothetical value for each of one or more agronomic inputs, in which the data for one of the agronomic scenarios is distinct from the data for each other one of the agronomic scenarios; and identifying one of the predicted values for the agronomic output as the hypothetical value for the agronomic output.

Identifying one of the predicted values for the agronomic output as the hypothetical value may include identifying a maximum or a minimum predicted value.

The actions of the method may include calculating a difference between the hypothetical value for the agronomic output of the farmable region and the measured value for the agronomic output of the farmable region for the period of time.

Identifying one or more of the agronomic inputs may include identifying an agronomic input for which the difference between the measured value and the hypothetical value for the agronomic input affects the difference between the hypothetical value and the measured value for the agronomic output.

The actions of the method may include identifying a value for each of one or more of the identified agronomic inputs that, when applied to the farmable region, can cause the difference between the measured value and the hypothetical value for the agronomic output to be decreased.

The actions of the method may include rendering the data for the graphical representation of the predicted value for the agronomic output.

The graphical representation may include a waterfall chart.

In general, another innovative aspect of the subject matter described in this specification can be embodied in a method including: obtaining data indicative of multiple agronomic scenarios, the data for each agronomic scenario including a value for each of one or more agronomic inputs, in which the data for each of the agronomic scenarios is distinct from the data for each other one of the agronomic scenarios; selecting one or more of the multiple agronomic scenarios based on the value for a particular one of the agronomic inputs for each of the agronomic scenarios; and for each of the selected agronomic scenarios: predicting a value for an agronomic output of a farmable region based on the value for each of the one or more agronomic inputs for the selected agronomic scenario.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. Selecting one or more of the agronomic scenarios may include selecting the agronomic scenarios having a maximum value or a minimum value for the particular one of the agronomic inputs.

Selecting one or more of the agronomic scenarios may include selecting the agronomic scenarios based on an entropy associated with the values for the agronomic inputs included in the selected agronomic scenarios.

The actions of the method may include determining a derived predicted value for the agronomic output based on the predicted value for the agronomic output for each of the selected agronomic scenarios.

The actions of the method may include determining a sensitivity of the agronomic output to a variation in the particular one of the agronomic inputs based on the derived predicted value for the agronomic output.

The actions of the method may include predicting the value for the agronomic output of the farmable region based on a value for each of one or more plant characteristics for a crop variety.

The actions of the method may include determining a sensitivity of the crop variety to a variation in the particular one of the agronomic inputs based on the predicted values for the agronomic output.

The actions of the method may include rendering a graphical representation of the sensitivity of the crop variety to the variation in the particular one of the agronomic inputs.

Details of one or more embodiments of the subject matter of this disclosure are set forth in the accompanying drawings and the description below. Other features, aspects, and advantages of the subject matter will become apparent from the description, the drawings, and the claims.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF DRAWINGS

Certain advantages of some embodiments may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

FIG. 1A is a diagram of an example of a system for obtaining agronomic data.

FIG. 1B is a diagram of some agronomic inputs of a farmable region.

FIG. 2 is a diagram of an agronomic simulator.

FIG. 3 is a diagram of a stochastic weather generator.

FIG. 4 is a flow chart.

FIGS. 5A and 5B are examples of data for stochastic weather generation.

FIG. 6 is a diagram of stochastic weather generation.

FIG. 7 is a diagram of generation of a distribution of predicted values for an agronomic output.

FIG. 8 is an example of distributions of predicted crop yields.

FIG. 9 is a diagram of multiple distributions of predicted values for an agronomic output.

FIG. 10 is a diagram of a process for calculating a net present value of a farmable region.

FIG. 11 is a flow chart.

FIG. 12 is a diagram of determining a performance assessment for a farm agent.

FIG. 13 is a diagram of determining root causes.

FIG. 14 is a waterfall chart.

FIG. 15 is a diagram of selection of input data.

FIG. 16 is a tornado chart.

FIG. 17 is a diagram of a computer system.

### DETAILED DESCRIPTION

Described herein is an approach to determining predicted values for agronomic outputs based on measured or hypothetical values for agronomic inputs for one or more farmable regions. The predicted values for the agronomic outputs can provide valuable insight into the performance of the farmable region that can be used, e.g., to improve crop yields from the farmable region. The predicted values for the agronomic outputs can be useful for determining a commercially relevant characterization associated with the one or more farmable regions. Such characterizations may include, for example, a level of risk, a commodity forecast, a financial value, a performance assessment, etc. In addition, the effect on an agronomic output of extreme values or highly variable values for one or more agronomic inputs can be determined, which can provide valuable information about the robustness or sensitivity of farming practices or crop varieties to those agronomic inputs.

As used herein, an “agronomic input” may include one or more agricultural and/or environmental characteristics related to the producing and/or using of plants (e.g., for food, feed, fiber, fuel, ornamentation, environmental or climatic modification, etc.). “Agricultural characteristics” may include cultivars and/or activities performed in the process of farming. “Environmental characteristics” may include one or more climate, weather conditions, atmospheric conditions, and/or soil conditions (e.g., of a region). “Weather conditions” may include, but are not limited to, precipitation (e.g., rainfall, snowfall, hail, or other types of precipitation), wind, and solar radiation. “Atmospheric conditions” may include, but are not limited to, carbon dioxide levels, ozone levels, and smog conditions. “Soil conditions” may include, but are not limited to, microbial presence, insect presence, weed presence, nematode presence, fungal organism presence, water table presence, location of water tables, and topography.

As used herein, an “agronomic output” may include a result of agronomic activity related to the agronomic inputs.

As used herein, an agronomic scenario may include a set of hypothetical values for one or more agronomic inputs. As used herein, an environmental scenario may include to a set of hypothetical values for one or more environmental characteristics.

As used herein, an “agronomic simulator” may include a system that estimates and/or predicts an agronomic output as a function of one or more agronomic inputs.

As used herein, a “farmable region” may include an area for which agronomic inputs can be determined, for which agronomic outputs can be predicted or simulated, and/or for which historical evaluation or diagnosis of agronomic inputs, outputs, or both can be performed. An historical diagnosis can be useful, e.g., when actual values for agronomic inputs and outputs are known and the root cause of the actual values for the agronomic outputs is determined (e.g., 10% more rain than normal was a direct cause of the observed crop yield), or to determine the value an intermediate agronomic input or output (which may be unobservable).

As used herein, a “farm agent” may include an entity, for example a person or corporation, with responsibility for agricultural operations in a farmable region.

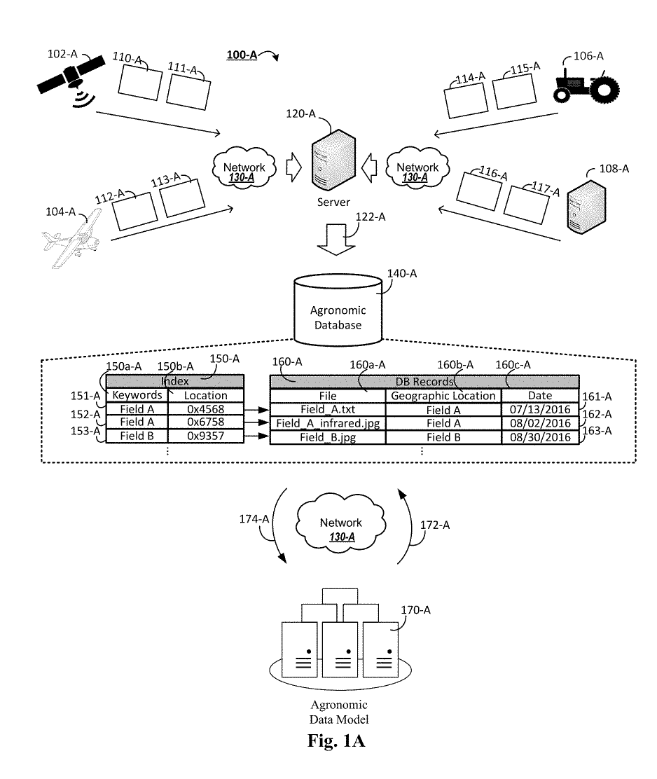

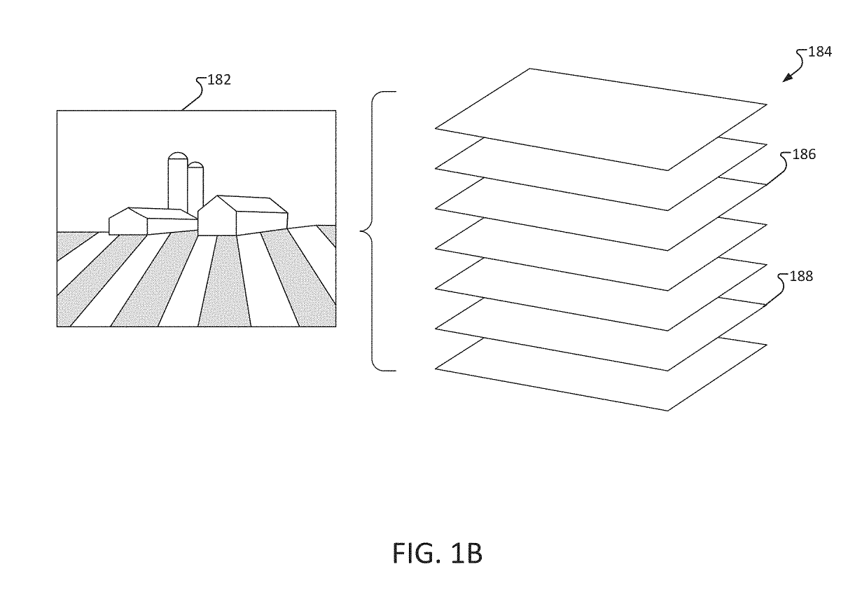

FIG. 1A is a diagram of an example of a system 100-A for obtaining agronomic data. The system 100-A may include at least one or more vehicles (e.g., a satellite 102-A, an airplane 104-A, or a tractor 106-A), at least one agronomic data providing server 108-A, a server 120-A, an agronomic database 140-A, and an agronomic data model 170-A.

Each of the vehicles may be equipped with one or more sensors capable of collecting agronomic data associated with a particular geographic region (e.g., a field of a farm). In some instances, the vehicles may include, for example, a satellite 102-A or an airplane 104-A equipped with one or more remote sensing devices for capturing image(s) of at least a portion of a geographic location. The images may include, for example, red-blue-green images, thermal images, infrared images, radar images, etc. Alternatively, or in addition, the vehicles may include a tractor 106-A equipped with one or more sensors capable of collecting agronomic data related to a particular portion of a geographic location that includes, for example, a plant's location (e.g., GPS location), the plant's weight, the plant's time of harvest, etc. Other types of vehicles may also be used to collect agronomic data associated with a particular portion of a geographic location. Such vehicles may include, for example, a drone. The agronomic data 110-A, 111-A, 112A, 113-A, 114-A, and 115-A captured by the vehicles may be transmitted via a network 130-A to a server 120-A. The network 130-A may include one or multiple networks, for example, a LAN, a WAN, a cellular network, the Internet, etc.

Alternatively, or in addition, agronomic data 116-A and 117-A may be obtained from one or more agronomic data providing servers 108-A. The server 108-A may, for example, house a database of historic agronomic data items from one or more geographic locations. For instance, the server 108-A may provide access to a database (e.g., a database hosted by a government agency, university, etc.) that tracks changes in agronomic data associated with particular geographic locations over time. The agronomic data 116-A, 117-A may be obtained from the server 108-A via a network 130-A.

Server 120-A may process the data 110-A, 111-A, 112-A, 113-A, 114-A, 115-A, 116-A, 117-A received via network 130-A and store 122-A the received data in an agronomic database 140-A. Processing the received data 110-A-117-A by server 120-A may include extracting relevant aspects of the received data for storage. Alternatively, or in addition, processing of the received data 110-A-117-A by server 120-A may include generating an index 150-A that can be used to efficiently access and retrieve the data 110-A-117-A once the data 110-A-117-A are stored as records 160-A in the agronomic database 140-A. The agronomic database 140-A may be hosted on the server 120-A. Alternatively, or in addition, the agronomic database may be hosted by one or more other servers.

The index 150-A may include one or more fields for each index entry 151-A, 152-A, 153-A, etc. Examples of index fields may include, for example, a keyword field 150a-A, a storage location field 150b-A, etc. In the example of system 100-A, the agronomic database 140-A may be configured to receive one or more search parameters for one or more database records (for example, search parameters requesting data related to “Field A”). In response to the receipt of such search parameters, the agronomic database 140-A may identify all the index entries matching the search parameter, identify the storage location 150b-A associated with each matching index entry, and access the database record(s) stored at the identified storage location(s). Though a particular example of an index 150-A and index fields 150a-A, 150b-A are provided herein, the present disclosure need not be so limited. Instead, any type of index may be used to index the data 110-A-117-A received and stored in the agronomic database 140-A so long as the data stored in the agronomic database 140-A can be accessed by the agronomic data model 170-A.

The data 110-A-117-A may be stored in the agronomic database 140-A as one or more database records 160-A. The agronomic database 140-A may store records in any logical database form (for example, a relational database, hierarchical database, column database, etc.). Instead of requiring the use of a particular logical database schema, the agronomic database 140-A may only require a configuration that allows the agronomic data stored by the agronomic database 140-A to be accessed by the agronomic data model 170-A. Some examples of the types of data that may be stored in agronomic database 140-A include a file 160a-A (e.g., an image file), a geographic location 160b-A associated with the stored file (or other agronomic data), a date 160c-A the data were captured, or the like. Any suitable type of data may be stored, and in some embodiments the types of data stored are determined based on the type of received data 110-A-117-A.

One or more server computers may provide access to the agronomic data model 170-A. The agronomic data model 170-A may request 172-A data from the agronomic database 140-A via a network 130-A. The requested data may be data that can be used to analyze agronomic inputs associated with a particular geographic location. Agronomic data responsive to the agronomic data model's 170-A request 172-A may be returned 174-A from the agronomic database 140-A to the agronomic data model 170-A via one or more networks 130-A. The agronomic data model 170-A may use the agronomic data returned 174-A from the agronomic database 140-A as an agronomic input to the model.

FIG. 1B illustrates components that describe some agronomic inputs of a farmable region 182. The farmable region can be a traditional field or a controlled (e.g., partially controlled) environment, for example, a greenhouse, a glass house, a shade house, a growth chamber, etc.

The agronomic output of the farmable region 182 can be influenced by one or more agronomic inputs. For example, crop yield (e.g., an amount of crops produced) in the farmable region 182 can be affected by one or more of rainfall, soil depth, nitrate levels, plant population, and/or other agronomic inputs. Each of these agronomic inputs can be considered as a separate variable or layer of a model of the farmable region 182. For instance, the farmable region 182 can be described by multiple layers 184, including, for example, a nitrogen layer 186, a rainfall layer 188, and/or other layers.

In general, if plant growth is different across a farmable region, the differences can be attributed to differences in one or more of the agronomic inputs of the farmable region. Accordingly, plants can be used as biological sensors that indicate agronomic inputs. Farm or remote sensing equipment can be equipped with location sensing devices, such as global positioning system (GPS) devices, allowing the location of individual plants or groups of plants to be determined.

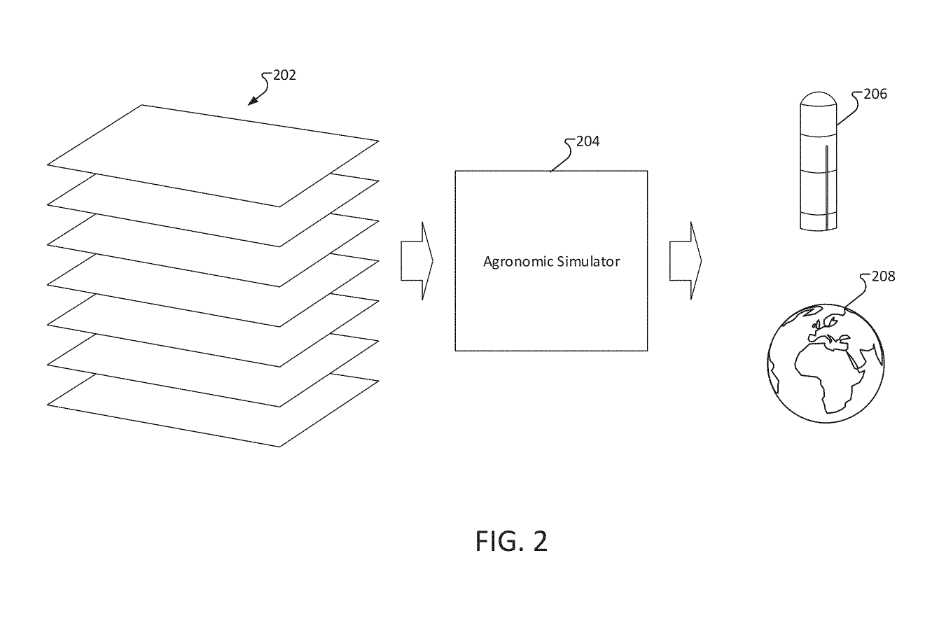

FIG. 2 illustrates providing agronomic inputs 202 to an agronomic simulator 204 to determine one or more agronomic outputs, such as crop yield 206, sustainability or environmental impact 208, or other agronomic outputs. An agronomic simulator is a system that applies the agronomic inputs to an agronomic model to estimate and/or predict one or more agronomic outputs related to producing and using plants for food, feed, fuel, fiber, ornamentation, or environmental or climatic modification.

Agronomic inputs can include both a type of agronomic input (e.g., sandiness) and a value for the agronomic input (e.g., 20%). In general, a change in an agronomic input refers to a change in the value for the agronomic input. Examples of agronomic inputs can include, but are not limited to: maximum ponding height; soil layer depth; saturated soil water content; soil bulk density; soil organic carbon content; soil clay content; soil sand content; soil silt content; soil stones (coarse fragment) content; lower limit of soil water availability; drained upper limit of soil water availability; saturated soil hydraulic conductivity; soil nitrogen content; soil pH; soil cation exchange capacity; soil calcium carbonate content; soil fresh organic matter (FOM) carbon, nitrogen and phosphorus content; soil active inorganic carbon content; soil slow inorganic carbon content; soil active inorganic phosphorus content; soil slow inorganic phosphorus content; soil mineral nitrogen including nitrate, ammonia and urea; air temperatures (including minimum and/or maximum); soil temperatures (including minimum and/or maximum); storm intensity (tightness of precipitation in time, for example, 1″ over 5 hours or in 5 minutes); elevation; solar radiation; precipitation; relative humidity; planting date; planting window dates; temperate thresholds for planting; soil moisture thresholds for planting; crop row spacing; planting depth; crop species; crop variety/cultivar; yield components of the variety/cultivar (for example, beans per pod, pods per plant, kernels per ear, ears per plant, etc.); length of developmental stages of variety/cultivar; compression of developmental stages of variety/cultivar; planting density; field irrigation; irrigation event water volume; irrigation event dates; irrigation drain depth; irrigation drain spacing; fertilizer date; fertilizer amount; fertilizer type (for example, manure, anhydrous ammonia, etc.); chemical composition of fertilizer type; fertilizer application depth; fertilizer incorporation percentage; harvest date; percent of stalk/leaves knocked down at harvest; percent of plant by-product harvested (leaves, etc.); percent of grain/fiber/fruit/etc. harvested; insect activity; plant hypoxia; weed growth; disease.

Agronomic outputs can include both a type of agronomic output (e.g., crop yield) and a value for the agronomic output (e.g., 175 bushels/acre). In general, a change in an agronomic output refers to a change in the value for the agronomic output.

Examples of agronomic outputs may include, but are not limited to, crop yield; sustainability; environmental impact; length of developmental stages of variety/cultivar; yield; leaf area index (LAI) over time; damage/death to the crop by frost, anoxia, heat, drought, etc.; dry weight of grains/fiber/fruit/veg; dry weight of shoots/areal plant parts; root depth; total root dry weight; change in biomass from previous time slice; daily and accumulated thermal time; radiation use efficiency; relative thermal time to maturity; current plant development phase; root weight, and of tillers; grain weight, and of tillers; total accumulated leaves or their equivalents; total accumulated phylochron intervals; leaf weight, and of tillers; weight of stem reserves, and of tillers; weight of stems, and of tillers; sink weight; source weight; below ground active organic nitrogen, carbon, phosphorus; below ground active inorganic nitrogen, carbon, phosphorus; atmospheric CO2; below ground fertilizer nitrogen, carbon, phosphorus; carbon in cumulative CO2 evolved; cumulative nitrogen fixed; cumulative harvested plant nitrogen and phosphorus; total nitrogen, carbon, phosphorus additions; below ground labile nitrogen and phosphorus; net nitrogen, carbon, phosphorus change; total nitrogen, carbon, phosphorus withdrawals; cumulative plant uptake of nitrogen and phosphorus; above ground rapid FOM nitrogen, carbon, phosphorus; below ground rapid FOM nitrogen, carbon, phosphorus; below ground resistant organic nitrogen, carbon, phosphorus; above ground interim FOM carbon; below ground interim FOM carbon; above ground slow FOM nitrogen, carbon; below ground slow FOM nitrogen, carbon; below ground slow organic nitrogen, carbon; below ground slow inorganic nitrogen, carbon; below ground solution nitrogen, phosphate; recognizable standing dead nitrogen, carbon, phosphorus; total nitrogen that can volatize; inorganic nitrogen in soil; cumulative nitrogen leached; organic nitrogen in soil; total nitrogen volatized; cold stress; drought; drought in stomatal conductivity; drought in turgidity; heat stress; nitrogen stress; phosphorus stress; photoperiod factor; cumulative drainage; potential cumulative evapotranspiration; potential evapotranspiration daily; cumulative plant transpiration; plant transpiration daily; cumulative soil evaporation; soil evaporation daily; cumulative evapotranspiration; evapotranspiration daily; cumulative irrigation; ponding height current; ponding height maximum; cumulative precipitation; cumulative runoff; potentially extractable water; and water table depth.

Agronomic inputs can be broken down by soil layer (e.g., by depth), over different time periods (for example, daily), and/or laterally (e.g., by location on a field). Lateral granularity can account for changes across a field or across multiple fields, such as changes in soil conditions, different crop/cultivar plantings in different locations on the same field, or other changes. For example, for every soil layer and for every time period agronomic outputs can also include, but are not limited to: new bulk density; downward water flux; net water flow; inorganic nitrogen in soil; root water uptake; dry weight of roots in the layer; soil temp; soil water content; soil hydraulic conductivity; upward water flux; active, slow, resistant organic carbon content's rapid, intermediate, and slow; total fresh organic matter content; soil carbon content; CO2 sequestration; active, slow and resistant organic nitrogen contents; ammonia content; N2O content; nitrogen content; urea content.

The agronomic simulator simulates agronomic activity based on provided agronomic inputs. The agronomic activity can be simulated using an agronomic model, such as the SYSTEM APPROACH TO LAND USE SUSTAINABILITY (SALUS) model or the CERES model. The SALUS model can model continuous crop, soil, water, atmospheric, and nutrient conditions under different management strategies for multiple years. These strategies may have various crop rotations, planting dates, plant populations, irrigation and fertilizer applications, and tillage regimes. The model can simulate plant growth and soil conditions every day (during growing seasons and fallow periods) for any time period when weather sequences are available or assumed. The model can account for farming and management practices such as tillage and residues, water balance, soil organic matter, nitrogen and phosphorous dynamics, heat balance, plant growth, plant development, presence of biotech traits, application of fungicides, application of pesticides, application of antimicrobials, application of nucleic acids, and application of biologicals. The water balance can consider surface runoff, infiltration, surface evaporation, saturated and unsaturated soil water flow, drainage, root water uptake, soil evaporation and transpiration. The soil organic matter and nutrient model can simulate organic matter decomposition, nitrogen mineralization and formation of ammonium and nitrate, nitrogen immobilization, gaseous nitrogen losses, and three pools of phosphorous.

The agronomic simulator can use any process or model that can predict the agronomic outputs based on provided agronomic inputs. For instance, the agronomic simulator can use a physical, generative or mechanistic model; a purely statistical or machine learning model; or a hybrid. In an example, the agronomic simulator can use a model that predicts agronomic outputs by attempting to match (by exact match or approximate match using, for instance, nearest neighbor) the provided agronomic inputs, or a transformation or function thereof (e.g., a dimensionality reduction, such as Principle Components Analysis or the outputs of an Indian Buffet Process or other latent factor model), with a collection of previously observed inputs and their matching outputs and predicting the output of the matched input.

In some examples, an agronomic simulator can use one or more non-analytic functions. An analytic function can be locally represented by a convergent power series; a non-analytic function cannot be locally represented by a convergent power series.

Further description of the agronomic simulator is provided in U.S. patent application Ser. No. 15/259,030, titled “Agronomic Database and Data Model” and filed on Sep. 7, 2016, the contents of which are hereby incorporated by reference herein to the maximum extent permitted by applicable law.

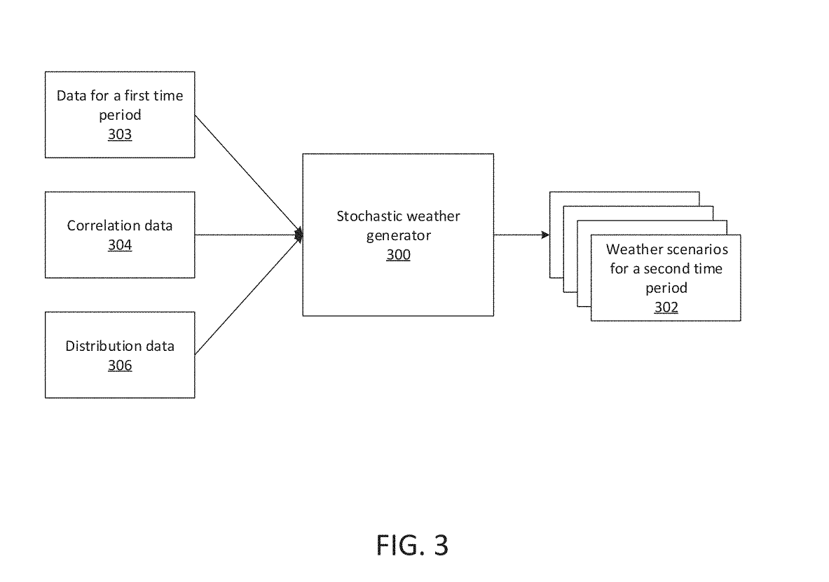

Referring to FIG. 3, a stochastic weather generator 300 generates data indicative of one or more hypothetical weather scenarios 302 for a time period. A hypothetical weather scenario is a set of hypothetical (e.g., neither predicted nor measured) values for environmental characteristics, such as weather characteristics (e.g., an amount of precipitation, an intensity of precipitation, a temperature, an amount of solar radiation, an amount of cloud cover, a humidity, or other weather characteristics) or other environmental characteristics. Data indicative of hypothetical weather scenarios 302 can be used as input data into an agronomic simulator to predict performance of a farmable region under various environmental conditions. For instance, the sensitivity of an agronomic output of a farmable region to various weather conditions can be estimated.

The stochastic weather generator 300 generates the data indicative of a hypothetical weather scenario 302 for a second time period based on data indicative of environmental characteristics for a first time period 303. The second time period can follow the first time period, e.g., the second time period can immediately follow the first time period. For instance, the first and second time periods can be consecutive days. The data indicative of environmental characteristics for a time period can include one or more of an amount of precipitation, a temperature (e.g., a maximum, minimum, or average temperature), a humidity (e.g., a maximum, minimum, or average humidity), an amount of solar radiation, or data indicative of another environmental characteristic. We sometimes refer to the data indicative of environmental characteristics for the first time period as an initial value for each of the environmental characteristics. The initial value can be a measured value (e.g., actual, measured weather data) or can be a value generated by the stochastic weather generator. We sometimes refer to the data indicative of environmental characteristics for the second time period as a hypothetical value for each of the environmental characteristics.

The stochastic weather generator 300 makes use of correlation data 304 and distribution data 306 to determine a hypothetical value for each of one or more environmental characteristics for the second time period. Correlation data are representative of a mathematical or statistical relationship among two or more values, such as a one-way relationship or a mutual relationship. In the context of the stochastic weather generator 300, correlation data indicate a statistical relationship between an initial value for each of one or more environmental characteristics for the first time period and a hypothetical value for each of one or more environmental characteristics for the second time period. Distribution data 306 for an environmental characteristic indicate a frequency distribution of values for the environmental characteristic, such as a frequency distribution of precipitation amounts or temperature.

In some examples, instead of or in addition to a stochastic weather generator, other approaches can be used, such as a numerical weather prediction engine, an atmospheric or climate model, or other tools used for weather forecasting. Statistical models can save computation. In some examples, a combination of one or more of the stochastic weather generator, the numerical weather prediction engine, and the atmospheric or climate model can be used.

In some examples, hypothetical values for environmental characteristics can be generated by matching historical scenarios, such as by making calico cats of various historical scenarios. By matching, we mean making a database of weather trajectories from real weather in any location, queryable by “closeness” to a given day's weather. In some examples, principal component analysis (PCA) can be used. In some examples, a probabilistic distance approach can be applied based on a clustering of real weather days and the probability that a weather day came from each cluster. Based on the matching, the next day is predicted as the next day that actually happened in the “matched” actual weather's actual next day. In some examples, non-best matches can be used to generate a series of calico cats of weather scenarios.

In some examples, the correlation data 304 relate an initial value for a particular environmental characteristic (e.g., today's temperature) for the first time period only to a hypothetical value for the same environmental characteristic (e.g., tomorrow's temperature) for the second time period. In some examples, the correlation data 304 relate the initial value for a particular environmental characteristic (e.g., today's temperature) for the first time period to a hypothetical value for each of multiple environmental characteristics (e.g., tomorrow's temperature and precipitation) for the second time period. In some examples, the correlation data 304 relate the initial value for each of multiple environmental characteristics (e.g., today's temperature and precipitation) for the first time period to a hypothetical value for each of multiple environmental characteristics (e.g., tomorrow's temperature and precipitation) for the second time period. In some examples, the correlation data 304 can relate an initial value for a particular environmental characteristic (e.g., today's precipitation) to a hypothetical value for a different environmental characteristic (e.g., tomorrow's temperature).

The correlation data 304 can be stored in data structure such as a table, a matrix, or another type of data structure. The data structure can be a multidimensional data structure that reflects interrelationships among the initial and hypothetical values for each of one or more of the environmental characteristics.

In some examples, there can be multiple underlying states, either discrete or continuous, and a probability of transitioning between states. Conditional on a state (meaning each state can have its own), there can be a multivariate distribution containing all variables, a series of univariate distributions one for each variable, or multiple distributions each with a subset of the variables. For instance, a weather generator can have two discrete states, one for rainy days and one for dry days. All possible transitions are valid and can be summarized in a 2×2 matrix with current states indicated as rows and next states indicated as columns. For instance, the upper right square holds the probability that we go from state 1 now to state 2 tomorrow. in this matrix, all rows must sum to 1 to account for all possible changes. The diagonal, which contains the elements for Dry→Dry and Wet→Wet day state transitions, have higher values than the other value on the same row, indicating that dry or rainy periods have hysteresis. This can also be represented and/or visualized as a Finite State Machine.

Based on the correlation data 304, a hypothetical value for each environmental characteristic that is correlated to the initial values can be determined. The resulting set of hypothetical values form a hypothetical weather scenario 302. Because the process for determining the hypothetical values is statistical, the process can be repeated to determining multiple, distinct hypothetical weather scenarios for the second time period that are all consistent with the initial values of the environmental characteristics for the first time period. The hypothetical weather scenarios can be provided as input into an agronomic simulator to simulate the performance of a farmable region in the face of the environmental variations represented by the multiple hypothetical weather scenarios.

In some examples, correlation data can be adjusted based on seasonal environmental characteristics to account for seasonal environmental variations that affect the relationships among environmental characteristics, such as El Nino or La Nina effects or other seasonal variations. Seasonal environmental characteristics are climate, weather, or soil conditions that are specific to a particular season. In some examples, correlation data can be adjusted to reflect increasing weather volatility due to climate change. In some examples, a factor can be added to the Gamma distribution discussed above to account for seasonal correction. In some examples, different distributions can be used to fit distributions for different years, such as for El Nino years versus years without El Nino.

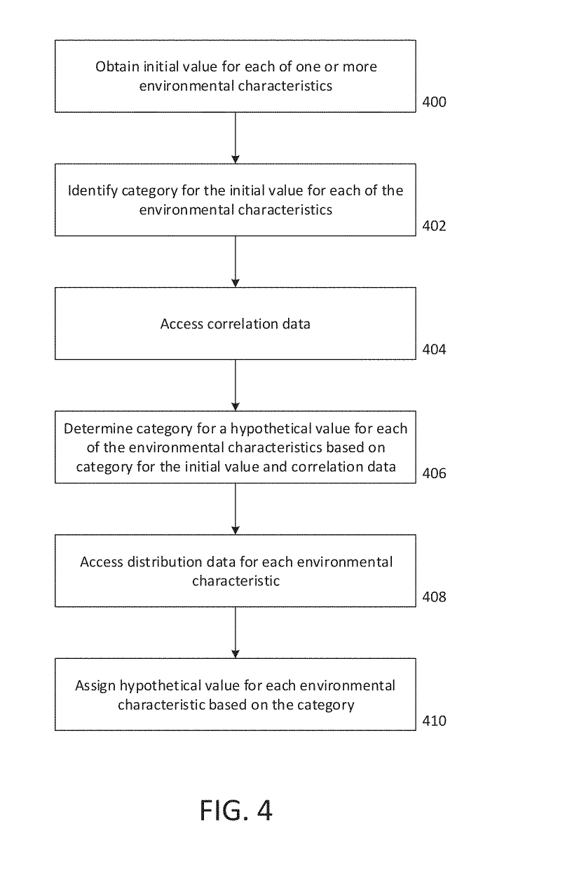

Referring to FIG. 4, in a process for generating data indicative of a hypothetical weather scenario, an initial value for each of one or more environmental characteristics is obtained (400). The initial value of an environmental characteristic can be a measured value (e.g., actual, measured weather data) or a value previously generated by the stochastic weather generator. The initial values are indicative of weather conditions for a certain period of time, such as a day. In an example, a measured maximum temperature, a measured total amount of precipitation, and an estimated total amount of solar radiation for a day are obtained.

A category for each initial value for each environmental characteristic is identified (402). Each environmental characteristic is associated with multiple categories, and each category is defined by a range of values for the weather characteristic or a quantitative description of the environmental characteristic. The initial value for a given environmental characteristic is assigned to a category for that environmental characteristic based on the magnitude of the initial value. In a specific example, temperature can be associated with five categories: Cold (below 32° F.), Cool (33° F.-50° F.), Moderate (51° F.-65° F.), Warm (66° F.-80° F.), and Hot (above 80° F.). Precipitation can be associated with four categories: None (no measurable precipitation), Low (less than 0.5 inches), Medium (0.5-1 inch), and High (greater than 1 inch). Solar radiation can be associated with four categories to which an initial value can be assigned based on a qualitative assessment of the level of solar radiation: Low, Medium, Medium-High, and High. Other environmental characteristics can also be associated with multiple categories.

In some examples, continuous categories can be used. In some examples, a combination of discrete and continuous categories can be used, such as a No Precipitation category and a continuous category for any non-zero precipitation. For instance, an autoregressive model can be used to implement discrete and continuous categories.

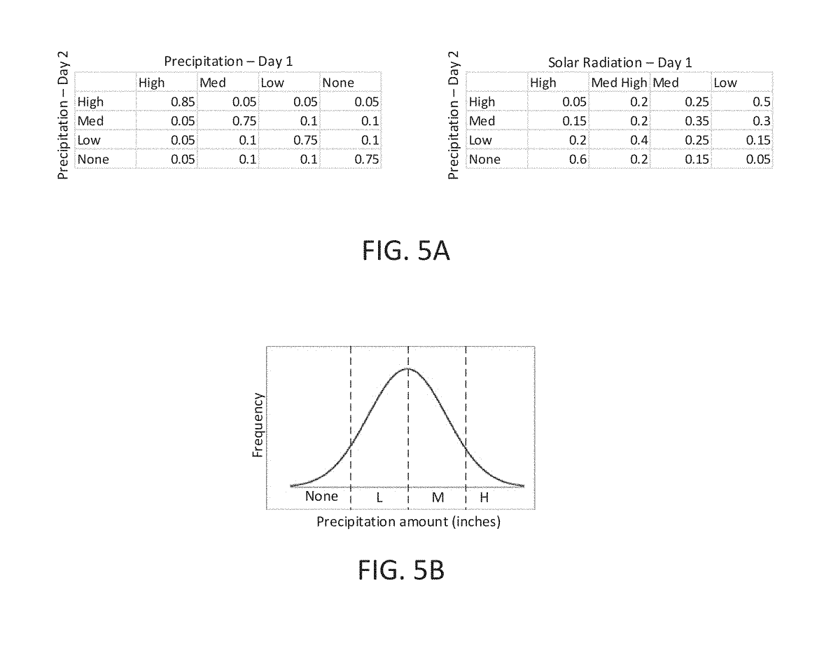

Correlation data is accessed for each environmental characteristic for which an initial value was obtained (404). The correlation data represent a statistical relationship among categories associated with one or more of the environmental characteristics, alone or in combinations. A portion of a multidimensional matrix of correlation data representing correlations among precipitation and solar radiation is shown in FIG. 5A.

Based on the category of the initial value for each environmental characteristic for the first time period and the correlation data, the stochastic weather generator determines a category of a hypothetical value for each environmental characteristic for the second time period (406). Referring also to FIG. 5A, in an example, the categories of the initial values of a first day are High precipitation and Low solar radiation. The correlation data, a portion of which are shown in FIG. 5A, indicate the statistical correlation between these initial categories and the category of the hypothetical value for the precipitation amount for the next day. In this example, the stochastic weather generator determines that the category of the hypothetical value for the precipitation amount for the next day is to be High. Other correlation data (not shown) can indicate correlations among categories of other environmental characteristics. Based on the multidimensional set of correlation data, the category of the hypothetical value for each environmental characteristic for the next day can be determined.

Distribution data is accessed for each environmental characteristic (408). The distribution data for an environmental characteristic indicates a distribution of values for the environmental characteristic and the values in the distribution that correspond to each of the categories for the environmental characteristic. An example of such distribution data is shown in FIG. 5B. Based on the distribution data, a specific value is assigned for the hypothetical value for each environmental characteristic (410). For instance, in the example of FIG. 5B, a value of 1.6 inches of precipitation is assigned for the hypothetical precipitation amount for the next day. Distribution data for other environmental characteristics can similarly be used to assign specific values to the hypothetical values for the other environmental characteristics. The resulting set of hypothetical values for environmental characteristics form a hypothetical weather scenario.

In some examples, a hypothetical weather scenario can represent a longer period of time and can include multiple values for each of one or more agronomic inputs, each value corresponding to a smaller time period within the longer time period. We refer to these hypothetical weather scenarios as longer term hypothetical weather scenarios. For instance, a longer term hypothetical weather scenario can represent a two-week period and can include a temperature and a precipitation value for each day during that two-week period. These longer term hypothetical weather scenarios can thus represent hypothetical weather patterns for a future two-week period. Within a single longer term hypothetical weather scenario, the value for an agronomic input for each smaller time period (e.g., each day) is determined according to correlation data and distribution data and according to the values for agronomic inputs for the preceding smaller time period (e.g., the previous day), as described above. Because of the statistical nature of the correlation data and the distribution data, each longer term hypothetical weather scenario can be distinct from each other hypothetical weather scenario.

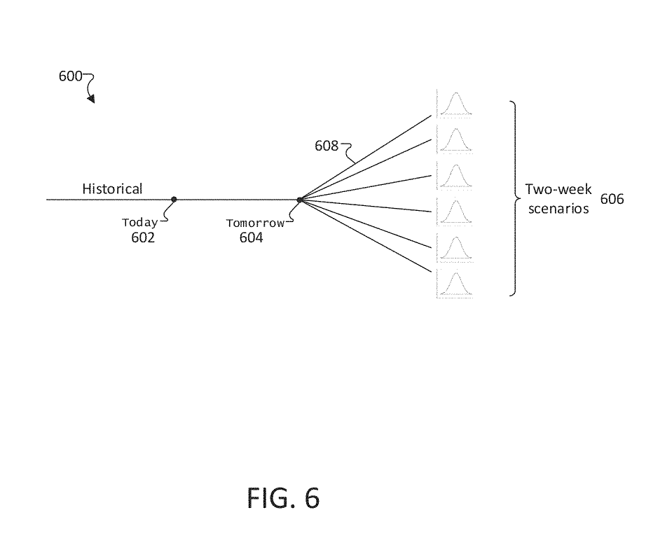

Referring to FIG. 6, in an illustration of a timeline 600, longer term hypothetical weather scenarios for a two week period of time are generated starting from data 602 indicative of environmental characteristic for a first time period, such as a first day. These data can be measured data (e.g., today's weather) or can be hypothetical data (e.g., data generated by a stochastic weather generator). For simplicity, we refer to the data 602 as today's data. Based on today's data 602, correlation data, and distribution data, a stochastic weather generator generates data 604 indicative of a hypothetical weather scenario for a second period of time following the first period of time. For simplicity, we refer to the data 604 as tomorrow's data. Based on tomorrow's data 604, correlation data, and distribution data, multiple longer term hypothetical weather scenarios 606 are generated for a longer period of time following the second period of time, such as for a two week period of time. Each of the longer term hypothetical weather scenarios 606 includes data 608 for multiple smaller time periods (e.g., individual days) within the longer time period.

In some examples, the longer term hypothetical weather scenarios can be developed based on a combination of numerical weather prediction (e.g., for the first two weeks) followed by statistical prediction for longer term forecasts.

In some examples, the multiple hypothetical weather scenarios can be used as input data into an agronomic simulator, which can generate predicted values for one or more agronomic outputs for a farmable region for each of the multiple weather scenarios. The distribution of the predicted values for an agronomic output across the multiple weather scenarios can provide an indication of the sensitivity of that agronomic output to variations in weather. In addition, the distribution of the predicted values for an agronomic output across the multiple weather scenarios can act as a forecast for future performance of the farmable region.

In some examples, information indicative of the confidence bounds of an agronomic output can be provided, e.g., as a report or notification. For instance, by running many weather scenarios, the probability that a given metric will be within any given set of bounds can be estimated. In some examples, the smallest width interval that contains a specific percentage of the probability mass of possible agronomic output values (e.g., 95%) can be identified and presented to a user, thus providing the user with a confident range of possible values. This process can be repeated, e.g., on a daily or weekly basis or at another interval, seeded with actual, to-date values. The repetition can result in a decreasing interval over the growing season which can ultimately converge to the actual, to-be-measured value for the agronomic output.

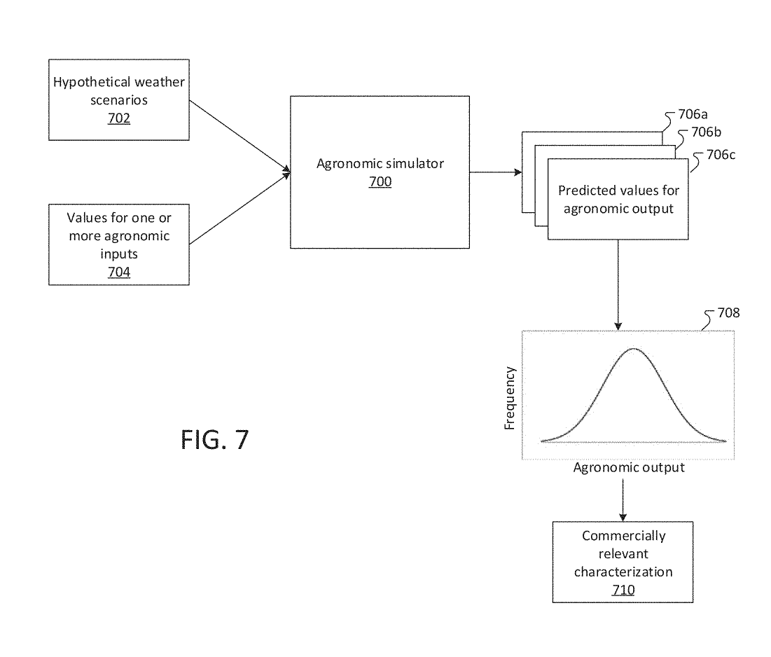

Referring to FIG. 7, an agronomic simulator 700 employs a model that predicts values for an agronomic output for a farmable region based on agronomic inputs for the farmable region and weather conditions for the farmable region. Data 702 indicative of multiple hypothetical weather scenarios is received into the agronomic simulator 700. The data indicative of multiple hypothetical weather scenarios can include data indicative of one or more of precipitation, temperature, solar radiation, humidity, and other weather conditions. In some examples, the data indicative of multiple hypothetical weather scenarios can have been generated by a stochastic weather generator such as that described above.

Data 704 indicative of a value for each of one or more agronomic inputs for the farmable region is also received into the agronomic simulator. In some examples, the data 704 can be measured values for the agronomic inputs, such as measured values for agronomic inputs known to have been applied to the farmable region. In some examples, the data 704 can be estimated values for the agronomic inputs, for instance, if a measured value for the agronomic input for the farmable region is not available.

The agronomic simulator 700 generates a predicted value 706a, 706b, 706c for an agronomic output for each of the multiple hypothetical weather scenarios for the farmable region. In some cases, one or more of the predicted values can be similar or identical, such as if the agronomic output is not significantly affected by changes in weather conditions or if the multiple hypothetical weather scenarios are not significantly different from each other. In some cases, each of the predicted values is different from each other of the predicted values.

The multiple predicted values 706a, 706b, 706c for the agronomic output for the farmable region can be depicted as a distribution 708 of the frequency of occurrence of each of the predicted values or a distribution of the frequency of occurrence of each of multiple ranges of predicted values. We sometimes refer to these distributions as distributions of the predicted values. The distribution 708 of the predicted values can be characterized by features such as a mean predicted value, a median predicted value, a standard deviation of the distribution 708, a mode of the distribution 708, a confidence interval of the distribution 708, or another characterization of the dispersion of the distribution 708, or other features of the distribution 708. In some examples, a parametric distribution or a machine learning model can be fit to the data and the fitted distribution can be characterized. Characterization of a fitted distribution can be useful, e.g., to smooth over a distribution that is not smooth because of a lack of samples, thus improving computational efficiency. For instance, a normal distribution or a Kernel density estimate can be fit to the data and a characterization of the fit, such as the mean, mode, or standard deviation of the fit, can be reported rather than a characterization of the distribution itself.

The characterization of the distribution 708 (or the fit to the distribution) can be used to develop a commercially relevant characterization 710 of the farmable region. A commercially relevant characterization may include a qualitative or quantitative description of the farmable region that can have commercial value. Examples of commercially relevant characterizations 710 of a farmable region can include, e.g., a qualitative or quantitative indication of a level of risk associated with the farmable region, an assignment of the farmable region to an insurance partition, a net present value (NPV) of the farmable region, or another commercially relevant characterization. In some examples, for each sample, a cost function can be applied to generate a net profit for the sample, and an integration over the distribution can be performed to obtain a weighted expected net profit under any scenario. In some examples, a risk term can also be included.

The dispersion (e.g., the standard deviation σ) of the distribution 708 of the predicted values for an agronomic output can provide an indication of how sensitive that agronomic output is to the weather variations represented by the multiple hypothetical weather scenarios. An agronomic output that is sensitive to weather variations is more likely to be inconsistent in the face of weather volatility. The sensitivity of an agronomic output for a farmable region to weather variations can thus be viewed as a proxy for a level of risk associated with that agronomic output for that farmable region.

In some examples, the sensitivity of each of multiple agronomic outputs to weather variations can be determined and the multiple agronomic outputs can be ranked by sensitivity. Ranking of agronomic outputs by sensitivity can be useful, e.g., to prioritize calibration of agronomic input variables for an agronomic simulator, thus improving the computational efficiency of the calibration process. Such rankings can also be useful, e.g., to prioritize values to determine values for use in a management optimizer, thus improving the computational efficiency of that system. In some examples, the rankings can be used to prune the variables attempted in a calibration process or a management optimization process, or to allocate more computational time or power to more sensitive variables. In some examples, the rankings can be used to help focus a research plan or to inform a farm agent about which variables to obtain ground-truth measurements from, so as to improve the accuracy of the model. In some examples, a report can be generated indicating the variables for which the farm agent is to obtain ground-truth measurements.

In some examples, the sensitivity of each of multiple agronomic outputs to weather variations can be used to determine which weather scenarios lead to the worst results, and thus which weather initial conditions or trajectories give the worst results. A score can be assigned to any given weather condition or string of weather conditions that reflects the desirability or undesirability of the resulting final values for the agronomic outputs. On the basis of weather conditions alone and without the use of an agronomic simulator, a crop insurer or commodity trader can predict movements or risk in final crop yields. For instance, given any real weather scenario prefix, the best match from among multiple hypothetical weather scenarios can be identified and the resulting value for the agronomic output from the identified hypothetical weather scenario can be reported as a prediction. Avoiding running an agronomic simulator can help improve the computational efficiency of the process. In an example, the data may indicate that a cool spring leads to a high likelihood of poor crop yields. Thus, for any year with a cool spring, crop yield predictions can be low.

In some examples, the level of risk associated with a farmable region can be quantified by the coefficient of variation of the distribution 708 of the predicted values for an agronomic output for the farmable region. The coefficient of variation is the ratio of the standard deviation (σ) of the distribution 708 to the mean μ of the distribution 708. In some examples, another metric, such as the standard deviation of the distribution, the standard error, a Risk Aversion Factor, or another metric, can be used to quantitatively characterize the level of risk.

The quantified level of risk associated with a farmable region can be used to make decisions regarding insurance policies for the farmable region, such as whether to issue an insurance policy, pricing for an insurance policy, a risk associated with an insurance policy, or other decisions. For instance, the coefficient of variation of an agronomic output associated with a farmable region can be used as a factor in underwriting an insurance policy for the farmable region. In some examples, a thresholding approach can be applied in which an insurance policy is more expensive or even unavailable for a farmable region if the coefficient of variation or another metric of an agronomic output associated with the farmable region exceeds a threshold value. In some examples, a partitioning approach can be applied in which a farmable region is assigned to one of multiple previously defined categories based on the coefficient of variation of an agronomic output associated with the farmable region. An insurance policy for the farmable region, such as a level of insurance coverage or a policy pricing, can be determined based on the category to which the farmable region is assigned.

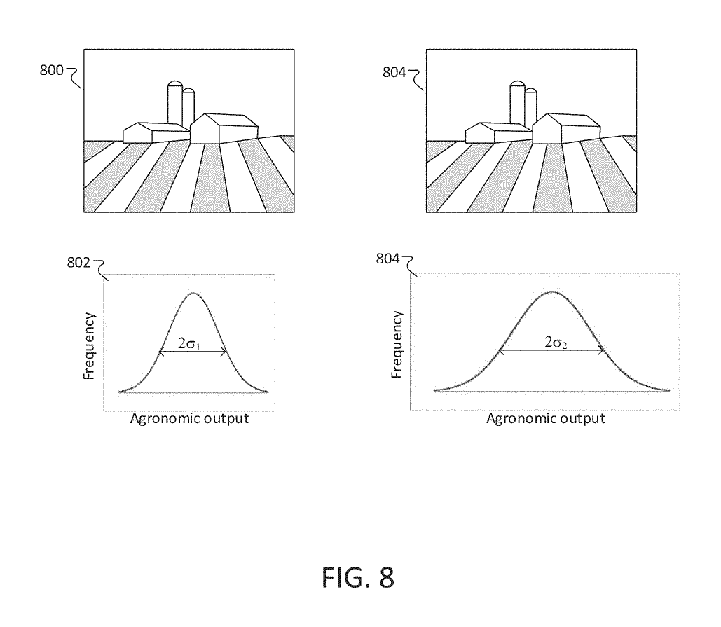

Referring to FIG. 8, in a specific example, a first cornfield 800 is characterized by a first distribution 802 of predicted crop yields across a set of multiple hypothetical weather scenarios. The first distribution 802 has a mean predicted crop yield μ and a standard deviation σ₁, and the level of risk associated with the first cornfield can be characterized by the coefficient of variation of the first distribution 802:

CV₁=σ₁/μ.

A second cornfield 804 is characterized by a second distribution 806 of predicted crop yields across the same set of multiple hypothetical weather scenarios. The second distribution 806 has the same mean predicted crop yield μ but a standard deviation σ₂ that is greater than the standard deviation σ₁ of the first distribution 802, indicating that the crop yield in the second cornfield is more sensitive to weather variations than the crop yield in the first cornfield. The level of risk associated with the second cornfield can be characterized by the coefficient of variation of the second distribution 806:

CV₂=σ₂/μ.

Because of the larger standard deviation of the second distribution 806, the coefficient of variation CV2 of the second cornfield 804 is greater than the coefficient of variation CV1 of the first cornfield 800. The second cornfield 804 can thus be regarded as a higher risk field than the first cornfield 800.

In some examples, the first and second distributions can have both different means and different standard deviations. A Risk Aversion Factor and an integral over the distribution (which produces an expected value) can be used to form a single dollar metric. The metric can be compared against a threshold and the results of the comparison can be used, e.g., to determine whether to grant an insurance policy, a price for the insurance policy, or other decisions.

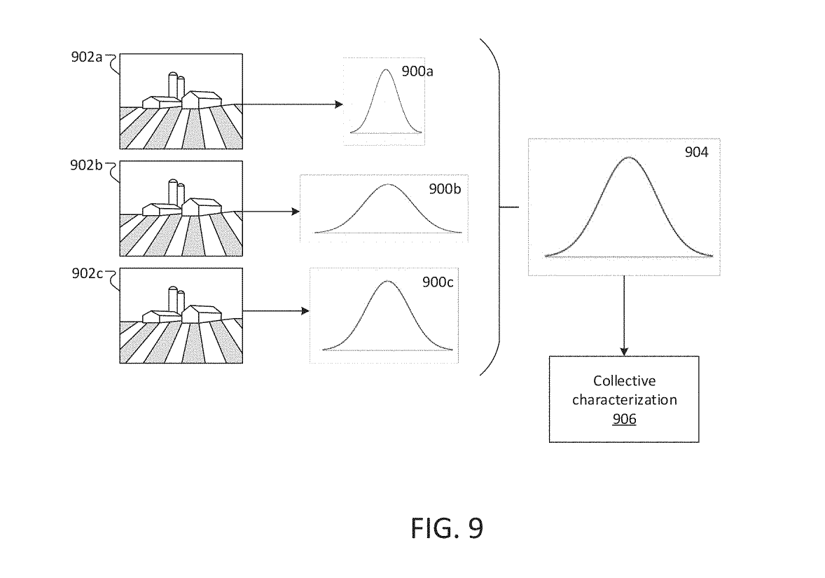

Referring to FIG. 9, in some examples, a distribution of predicted values 900a, 900b, 900c for an agronomic output can be determined for each of multiple farmable regions 902a, 902b, 902c. The multiple distributions 900a, 900b, 900c can be combined into a single, derived distribution 904. For instance, the derived distribution 904 can be a sum, an average, or another combination of the multiple distributions 900a, 900b, 900c. A characteristic of the derived distribution 904, such as a mean a standard deviation 6, a coefficient of variation, or another characteristic can be used to determine a collective characterization 906 of the multiple farmable regions 902a, 902b, 902c. The collective characterization 906 of the multiple farmable regions 902a, 902b, 902c can be a commercially relevant characterization, such as a commodity forecast, a predicted planting or harvest date, or another commercially relevant characterization of the multiple farmable regions 902a, 902b, 902c. A commodity forecast is a prediction of future volume, price, risk, and/or volatility of a commodity.

In some examples, the commodity forecast can be relevant across multiple farms, such as most farms in the United States or in a region of the United States, a set of representative farms, or a weighted set of representative farms. The values for an agronomic output (e.g., crop yield) across the multiple farms can be summed and multiplied by a weighting factor, if appropriate, to produce a forecast. In addition, to produce a measure of uncertainty along with the forecast, in some examples, independent scenarios can be run for each field and a distribution can be created based on all random combinations of the results of the independent scenarios. This approach is computationally intensive and can be inaccurate, e.g., because weather is partially correlated across locations. In some examples, to produce a measure of uncertainty along with the forecast, a set of weather scenarios and associated outcomes for each location can be produced and turned into a statistical parametric distribution (e.g., normal, log normal, or another type of distribution). The distributions can then be analytically summed, thus saving computation. In some examples, historical whole year weather scenarios (using actual data rather than hypothetical data) can be used to feed the agronomic simulator, and the correlation between the output variable (e.g., crop yield) and each pair of field locations or representative field locations can be characterized. This estimate of the correlation can then be used to compute a standard deviation in the analytically summed results of the statistical distribution fit scenario outcomes. Such an approach is accurate and less computationally intensive.

In some examples, in a system, the correlations of outcomes are known in a same year (e.g., historical ground truth yields at locations are known). In addition, data or predictions are known for one location. Two different predictions can be made for a second site: (i) simulation using available data at the second site and (ii) using correlation to the first site and the prediction at the first site. If the two predictions disagree substantially, this can be an indication that the weather data or values for an agronomic input are suspect. In addition, it can be possible to globally calibrate fields by trying to both match outcomes and correlations across fields.

In an example, the multiple farmable regions 902a, 902b, 902c are soy fields in Iowa and the distributions 900a, 900b, 900c are distributions of predicted crop yields for each of the multiple soy fields. The distributions of predicted crop yields 900a, 900b, 900c are added together to generate the derived distribution 904, which is representative of the aggregate predicted crop yield for the multiple soy fields. The mean μ of the derived distribution 904, which indicates the mean aggregate predicted yield of soy from the multiple soy fields 902a, 902b, 902c, can be used to generate a commodity volume forecast for expected soy production. The standard deviation 6 of the derived distribution 904, which represents the variability of the predicted aggregate yield, is an indicator of the degree of confidence in the mean aggregate predicted yield of soy and can be used as a factor in pricing soybean futures contracts.

In some examples, the distributions 900a, 900b, 900c can be determined based on longer term hypothetical weather scenarios, such as the two-week hypothetical weather scenarios 606 of FIG. 6. The derived distribution 904 will thus be based on the distribution of values for an agronomic output at a time a long time in the future, such as the time from planting to harvest. A collective characterization 906 determined based on such future data can be valuable for commodity forecasting.

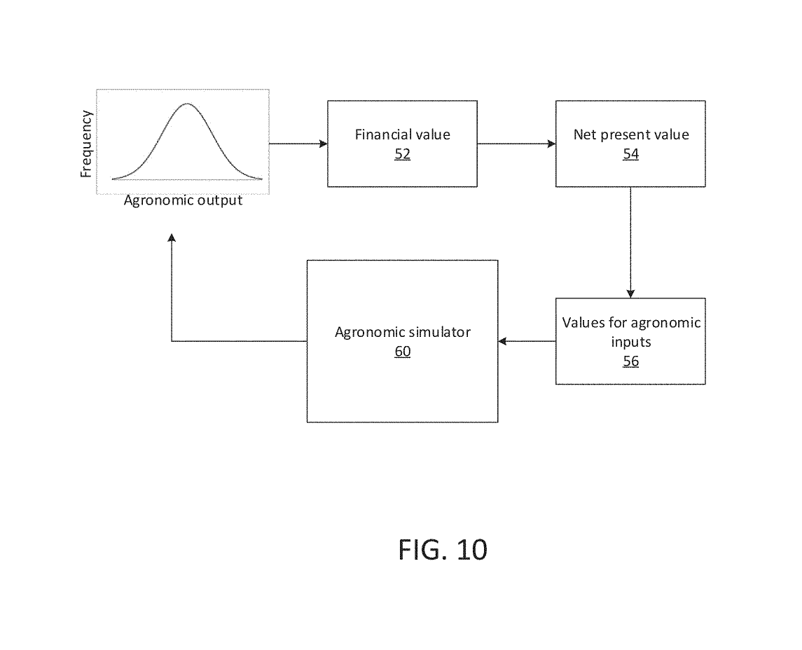

Referring to FIG. 10, in some examples, a distribution of predicted values 50 for an agronomic output (e.g., a crop yield) for a farmable region across multiple hypothetical weather scenarios can be used to estimate a measure of potential financial value 52 associated with the farmable region across the multiple weather scenarios. The measure of potential financial value can be one or a combination of potential profit, potential revenue, potential costs, potential risks, or another measure of financial value. In some examples, the measure of potential financial value 52 can be used to calculate a net present value (NPV) 54 of the farmable region. The NPV of a farmable region is the value of the farmable region in the present.

In some examples, an iterative process can be performed to identify values for agronomic inputs that can increase or maximize the NPV of a farmable region, reduce or minimize the environmental impact of the farmable region, a weighted combination of increased NPV and decreased environmental impact, or another increase or decrease another objective function. For instance, once the NPV 54 of the farmable region has been determined, values for one or agronomic inputs 56 that maximize the NPV are identified. These values 56 are provided as input into an agronomic simulator 60, which generates an updated version of the distribution of predicted values 50 for the agronomic output. Based on the updated version of the distribution 50, an updated NPV 54 can be calculated. The iterative process can repeat until a target NPV 54 (e.g., a maximum NPV) is achieved.

An objective function can be a function of both inputs and outputs. For instance, planting density equates to the number of seeds which is an input cost, yield out can be sold is revenue, including risk aversion. It is possible to calculate NPV over ten years, as a farm agent may be building nitrogen and carbon in the soil by good management practices such as planting soil and not tilling, that add value only in the future.

A collapsing function reduces multiple objective function scores, one for each of multiple scenarios, into a single value for the objective function.

A sampler, search, or metaheuristic can be used to alter the values of a set of agronomic inputs to maximize or minimize the objective function.

A set of constraints can be defined, such as a farm agent being prohibited from entering a wet field.

An agronomic simulator can be run to obtain the agronomic outputs. A stochastic weather generator can be run to generate the weather scenarios.

A policy can be defined for optimization. The policy can be a set of variables or can have a functional form and, e.g., can have conditional logic. For instance, a policy can be “plant when the soil temperature first is greater than X degrees for Y days and the soil moisture is greater than Z % saturated and less than T % saturated.” The approach can solve not for the planting date but for X, Y, Z, and T. This approach can allow better solutions to be obtained and can offer improved computational efficiency over the alternative of providing a different desired value for every possible weather scenario. This is a policy that is robust against weather scenarios.

In some examples, a metaheuristic can be used to optimize the objective function by picking values for the policy, scored by running the agronomic simulator for each scenario.

The target NPV 54 can be used to assign a valuation to the farmable region. A valuation is an estimate of the monetary worth of the farmable region. The valuation can be used for activities such as obtaining financing for a purchase of the farmable region, withdrawing equity from the farmable region, determining an appropriate level of insurance coverage, estimating a tax assessment, setting a sale or lease price, estimating a value associated with leasing and farming the farmable region, or for other purposes. The values for the one or more agronomic inputs 56 that correspond to the target NPV 54 can be provided as a recommendation to a farm agent associated with the farmable region to assist the farm agent in managing the farmable region to achieve the target NPV 54.

In some examples, the distribution of predicted values for an agronomic output across multiple hypothetical weather scenarios for a farmable region can be analyzed in view of one or more constraints (e.g., one or more restrictions) to identify a desired value for the agronomic output. For instance, the desired value for the agronomic output can be a maximum or a minimum value for the agronomic output that satisfies the one or more constraints. The desired value for the agronomic output for a farmable region can be used to determine a commercially relevant characterization associated with the farmable region.

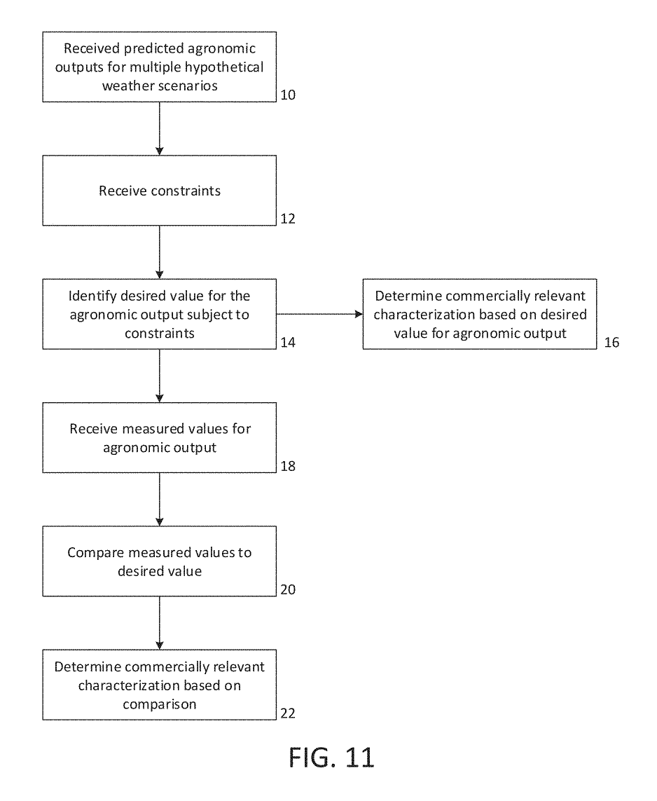

Referring to FIG. 11, predicted agronomic outputs for a farmable region for multiple hypothetical weather scenarios are received (10). The predicted agronomic outputs can have been determined by an agronomic simulator, e.g., as described above. One or more objective functions are received (12). The one or more objective functions can be financial in nature (e.g., minimization of cost, maximization of profit, or another type of financial constraint), objective functions associated with agronomic inputs (e.g., a target range for a harvest date, an allowable or prohibited type of fertilizer, or another type of constraint on an agronomic input), objective functions associated with the agronomic output (e.g., maximization or minimization of the value of the agronomic output), or another objective function. In addition, constraints can be applied. An example constraint is that once plants in a field reach a certain height, a tractor can no longer be used to fertilize the field because the plants will not fit under the tractor. An example constraint is that a tractor cannot be driven on muddy soil. An example constraint is that a farmer has limited liquidity or access to credit and thus has a cap on input costs, even if increasing input costs would be more NPV positive.

A desired value for the agronomic output is identified subject to the one or more objective functions (14). For instance, the distribution of predicted values for the agronomic output can be expressed as a function of one or more agronomic inputs. To identify a desired value for the agronomic output, an optimization analysis can be performed on the function to identify a maximum or minimum value for the agronomic output that satisfies an objective function associated with each of one or more of the agronomic inputs, an objective function associated with the agronomic output, or another objective functions. In some examples, a true optimum value or a local optimal value can be identified.

In some examples, a commercially relevant characterization associated with the farmable region can be determined based on the desired value (16). The commercially relevant characterization can be an identification of a value for each of one or more agronomic inputs that enables a value close to the desired value for the agronomic output to be achieved. In some examples, the value close to the desired value that is also the cheapest or lowest risk option can be identified. A value that is close to the desired value for an agronomic output can be a value that is within a certain amount of the desired value, such as a value that is within about 1%, within about 5%, within about 10%, within about 15%, within about 20%, or within another amount of the desired value for the agronomic output.

In a specific example, the agronomic output is crop yield from a farmable region. A maximum crop yield is identified subject to constraints related to application of fertilizer, such as an earliest and a latest possible date for application of fertilizer, a minimum or maximum value for a measure soil trafficability beyond which fertilizer cannot be applied, or other constraints related to fertilizer application; and constraints related to financial value, such as a maximization of revenue or profit, a minimization of cost, or other constraints related to financial value. The resulting analysis can identify a maximum crop yield that can be achieved from the farmable region and can identify a value for one or more agronomic inputs that can enable a value close to the maximum crop yield to be achieved. For instance, the analysis can identify one or more target dates for application of fertilizer.

In some examples, a commercially relevant characterization associated with the farmable region can be determined based on a comparison between the desired value for the agronomic output for a farmable region and a measured value for the agronomic output. One or more measured values for the agronomic output are received (18). The measured values can be values measured during a current farming season, values measured during a previous farming season, or both. The measured values for the agronomic output are compared to the desired value for the agronomic output (20). If there are multiple measured values for the agronomic output, such as measured values from multiple previous farming seasons, multiple measured values from a single farming season, or both, a derived measured value for the agronomic output can be compared to the desired value for the agronomic output. The derived measured value can be determined based on the multiple measured values. For instance, the derived measured value can be an average of the multiple measured values, a maximum or minimum value from among the multiple measured values, or another value derived from the multiple measured values.

A score for a farm agent can be obtained. We have multiple matched measured and optimized yields, so can compare multiple differences and summarize the distribution of the differences. A consistent negative gap/yield gap suggests poor performance by the farm agent. A larger negative gap suggests increasingly poor performance. Based on the gap, insurance pricing can be set, e.g., a large gap suggests high priced insurance; employment opportunities can be determined, e.g., the farm agent can lose a role as a seed producer; land can be repurposed, e.g., sold to a private equity firm to revamp into something more profitable.

In some examples, a yield map each year can be compared to desired yields and a farm agent scored based on the comparison, and insurance premiums can be set based on the score.

In some examples, farm agent performance scores can be used to allocate seed production contracts. For instance, based on performance scores during a trial period, seed production contracts can be allocated. In some examples, a land owner can select a farm agent to farm with profit sharing based on the farm agent's farm score.

In some examples, yield trials for a new product or cropping system on someone else's land, e.g., on a trial plot, can be obtained. That product or system can be simulated on another farm agent's land and also based on that other farm agent's performance score versus the outcome on the trial plot, for an accurate gauge of how the product or system will perform on the other farm agent's land. Thus, there are two sites, two measured, two optimized, thus two scores. There is treatment on one, other effects have been removed by simulator, then operator ability is removed from one to obtain true effect, and discount on the other site to obtain an estimate.

The commercially relevant characterization associated with the farmable region is determined based on the results of the comparison (22). The commercially relevant characterization can be a performance assessment (e.g., a performance evaluation) of a farm agent associated with the farmable region, e.g., an assessment of whether the farm agent was able to manage the farmable region to achieve a value close to the desired value for an agronomic output. The commercially relevant characterization can be an identification of one or more reasons why a farmable region failed to achieve a value close to the desired value for an agronomic output. The commercially relevant characterization can be a recommendation for one or more interventions that can be applied by a farm agent to improve the performance of a farmable region. An intervention is an action that can be taken in the real world. An example of an intervention is a change in a value for each of one or more agronomic inputs that can be applied to shift the performance of the farmable region closer to the desired value for an agronomic output.

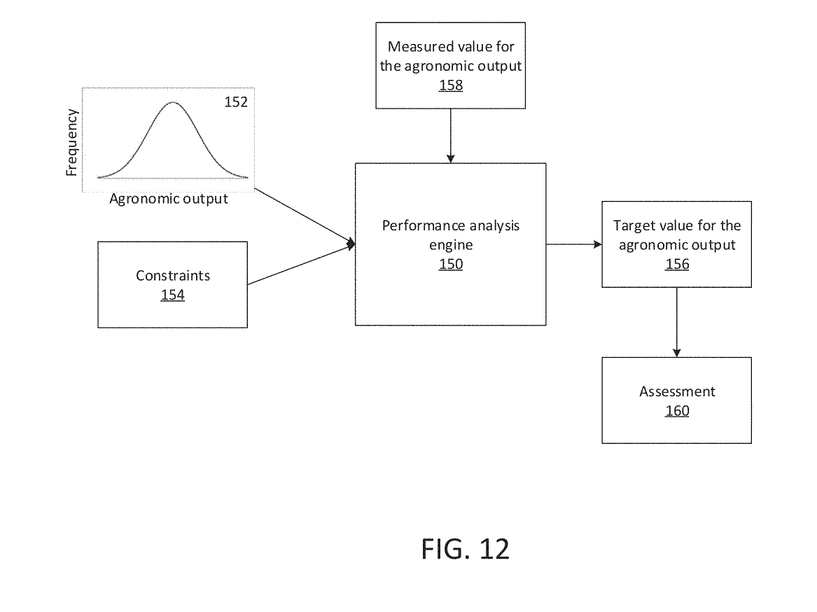

FIG. 12 shows an example approach for determining a performance assessment of a farm agent associated with a farmable region. A distribution 152 of predicted values for an agronomic output for the farmable region is processed by a performance analysis engine 150 in view of one or more constraints 154 to obtain a desired value 156 for the agronomic output. A measured value 158 or a derived measured value for the agronomic output for the farmable region is compared to the desired value 156 for the agronomic output. The measured value can be a value measured during a current farming season or a value measured during a previous farming season. The derived measured value can be derived based on one or more values measured during a current farming season, one or more values measured during a previous farming season, or both.

An assessment 160 of the farm agent can be determined based on results of the comparison between the measured value 158 or derived measured value and the desired value 156. In some examples, the assessment 160 can be a binary assessment indicating whether the performance of the farm agent meets a threshold performance or falls short of the threshold performance. If the difference between the measured value 158 or derived measured value and the desired value 156 is below a threshold level, the assessment 160 can indicate that the farm agent has been successful in management of the farmable region. For instance, if the measured value is able within about 1%, within about 5%, within about 10%, within about 15%, within about 20%, or within another threshold of the desired value, the farm agent can be assessed as successful. If the difference between the measured value 158 or derived measured value and the desired value 156 is above the threshold level, the assessment 160 can indicate that the farm agent has been unable to manage the farmable region to achieve the desired value for the agronomic output. In some examples, the assessment 160 can assign one of multiple grades or other performance indicators to the farm agent based on the magnitude of the difference between the measured values 158 and the desired value 156.

In some examples, an assessment 160 of the farm agent can be determined for each of multiple measured values 158, such as a measured value for each of multiple farming seasons. In this way, the performance of the farm agent can be tracked over a period of time. A trend in the assessments 160 of the farm agent can indicate whether the performance of the farm agent has improved or declined. Furthermore, with multiple assessments, an outlier (e.g., a season with unusually good or poor performance) can be identified and disregarded, if desired.

In an example, the agronomic output is a crop yield. To determine an assessment of a farm agent managing a farmable region, a target crop yield for the farmable region is determined subject to two constraints: (1) maximization of crop yield and (2) minimization of cost. A measured crop yield for the farmable region for each of multiple previous farm seasons is compared to the target crop yield. A difference of less than 10% between the measured crop yield and the target crop yield results in a rating of “Good.” A difference of more than 50% between the measured crop yield and the target crop yield results in a rating of “Poor.” Any other performance results in a rating of “Acceptable.” In this example, the assessment 160 of the farm agent indicates that the farm agent has had generally acceptable performance, with one year of good performance.

In the example of FIG. 12, the assessment 160 is indicative of the performance of the farm agent with respect to one farmable region. In some examples, an assessment can be determined that is indicative of the performance of the farm agent with respect to multiple farmable regions with which the farm agent is associated. In some examples, a derived assessment can be determined based on an assessment for each of multiple farmable regions. For instance, the derived assessment can be an average of the assessments for the multiple farmable regions. In some examples, a derived assessment can be determined based on the difference between each measured value for an agronomic output and the desired value for the agronomic output. For instance, the derived assessment can be based on the average difference between the measured values and the desired value.

Performance assessments of a farm agent can be used as a factor in underwriting an insurance policy for a farmable region with which the farm agent is associated. For instance, a level of insurance coverage or a policy pricing can be determined based on the performance assessment of a farm agent.

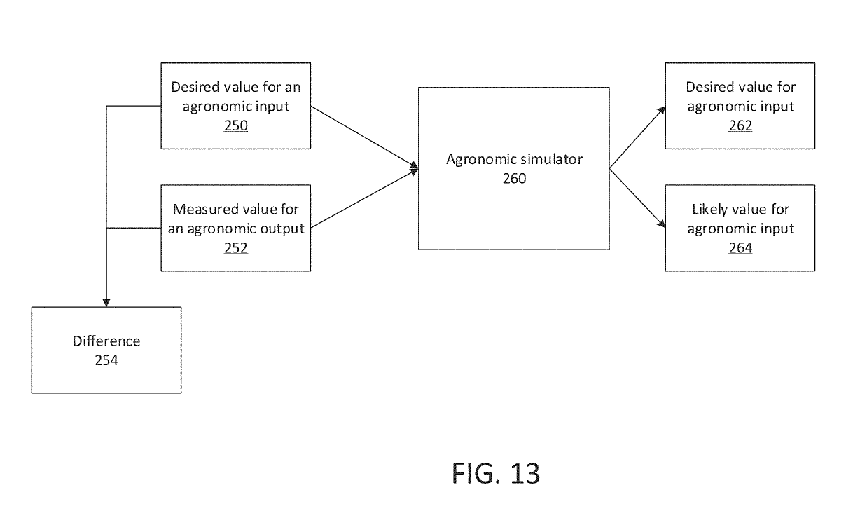

FIG. 13 shows an example approach for identifying root causes of a difference between a measured value for an agronomic output for a farmable region and a desired value for the agronomic output for the farmable region. A desired value 250 for an agronomic output for a farmable region (e.g., obtained from an analysis of a distribution of predicted values in view of one or more constraints, as described above) is compared to a measured value 252 for the agronomic output for the farmable region. The measured value 252 for the agronomic output is indicative of the actual performance of the farmable region, while the desired value 250 is indicative of a potential performance that can be achieved. A difference 254 between the measured value 252 and the desired value 250 indicates that the farmable region has not performed to its full technical potential. The technical potential can be, e.g., highest yield recorded, highest yield achievable on this field in a percentile of weather scenarios under good (e.g., optimal) management, or another technical potential. For instance, given all possible weather scenarios, under optimal management, the yield in the first percentile were, e.g., 325 bushels.

An agronomic simulator 260 can be used to obtain an understanding of the root causes underlying the difference 254 between the measured value 252 and the desired value 250. The agronomic simulator 260 is operated to identify a desired value 262 for each of one or more agronomic inputs that are consistent with the desired value 250 for the agronomic output. A value for an agronomic input that is consistent with a value for an agronomic output of a farmable region is a value for the agronomic input that could have produced the value for the agronomic output according to an agronomic model for the farmable region. The agronomic simulator 260 is also operated to identify likely values 264 for one or more agronomic inputs that are consistent with the measured value 252 for the agronomic output. In some cases, when actual values for one or more agronomic inputs for the farmable region are known, these actual values can be provided as input into the agronomic simulator, and the agronomic simulator 260 identifies likely values 264 for one or more other agronomic inputs that are consistent with both the measured value 252 for the agronomic output and the actual values for the agronomic inputs.

Values for agronomic inputs for a farmable region can be determined using different metaheuristic techniques, such as a Markov chain Monte Carlo (MCMC) and approximate Bayesian computations or Simulated Annealing. Other metaheuristics can include genetic algorithms, differential evolution, particle swarm optimization, ant colony algorithms, tabu search, stochastic gradient ascent/descent, simultaneous perturbation stochastic approximation (SPSA), Differential Evolution Adaptive Metropolis (DREAM), and Hamiltonian MCMC. These methods enable the solution of optimization problems in large dimensional spaces.

Determining values for agronomic inputs can be an iterative process that tries different combinations of agronomic inputs and different values for each agronomic input. The meta-heuristic can be used, for example, to generate multiple different alternative values for the agronomic inputs. In some examples, the metaheuristic mechanism can be enumerating all possible values, or a gridded set of values, for the agronomic inputs. In some examples, the metaheuristic mechanism can be performing a random search of a number of possible values for the agronomic inputs.

Further description of determining values for agronomic inputs is provided in U.S. patent application Ser. No. 15/259,030, titled “Agronomic Database and Data Model” and filed on Sep. 7, 2016, the contents of which are hereby incorporated by reference herein to the maximum extent permitted by applicable law.

An agronomic input for which there is a difference between the actual value and the likely value 264 or the desired value can be a root cause of the difference between the measured value for an agronomic output for a farmable region and the desired value for the agronomic output for the farmable region. In some examples, the root causes are divided into a set of exogenous root causes and a set of endogenous root cases. Exogenous root causes are agronomic inputs over which a farm agent has little or no control, such as agronomic inputs related to weather, insect population, or other exogenous agronomic inputs. Endogenous root causes are agronomic inputs that are primarily under the control of a farm agent, such as planting or harvest dates, planting characteristics such as crop row spacing or planting depth, agronomic inputs related to irrigation or fertilization, or other exogenous agronomic inputs.

In some examples, system effects can be accounted for. In some examples, root causes can be identified by subtracting from the desired values for each agronomic output, the one parameter to likely, or doing all likely and each parameter to optimized, or both, to indicate systems effects (e.g., non-linear or synergistic effects). In some examples, combinatorial approaches can be used. For instance, systems effects across two years and three variables can be accounted for.

In some examples, a recommendation can be provided, e.g., to a farm agent, based on the identification of the root causes of the difference between the measured and desired values for the agronomic output. The recommendation can identify one or more interventions that, when applied to the farmable region, may contribute to reducing the difference between the measured and desired values for the agronomic output. For instance, the recommendation can identify the exogenous root causes of the difference and can indicate how the agronomic inputs corresponding to those root causes can be adjusted. In some examples, the recommendation can be a quantitative recommendation (e.g., plant 10% more plants, apply fertilizer 1 week earlier). In some examples, the recommendation 366 can be a qualitative recommendation (e.g., increase nitrogen content of the soil, select a different plant variety).

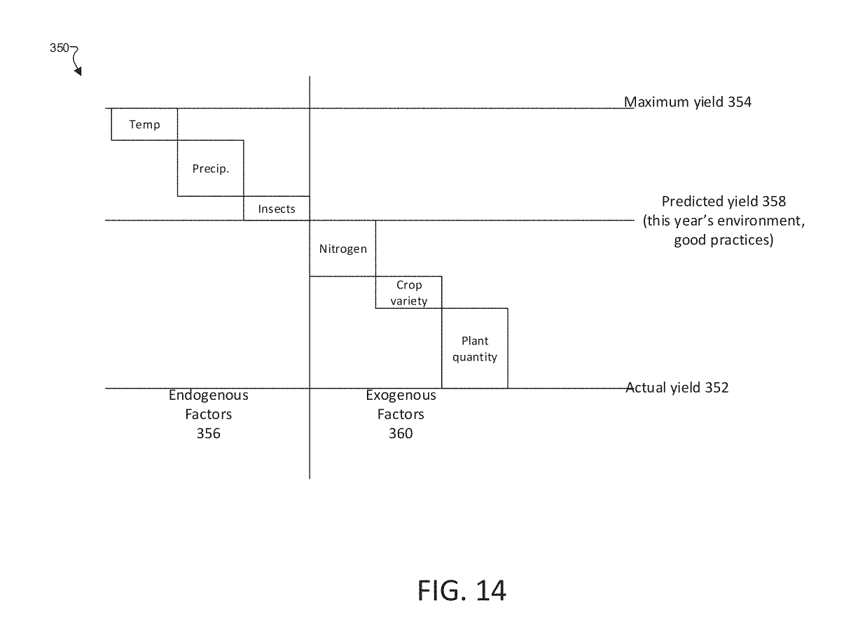

Referring to FIG. 14, in some examples, the root causes of the difference between the measured value and the desired value for an agronomic output for a farmable region can be depicted in a graphical representation, such as a waterfall chart 350. A waterfall chart is a chart that displays the cumulative effect of one or more agronomic inputs on the agronomic output. The waterfall chart or other type of graphical representation can visually depict the root causes in an easily understandable manner, e.g., to illustrate the magnitude of the effect of each root cause, to illustrate differences between endogenous and exogenous root causes, or to illustrate other features.

In the example of FIG. 14, the waterfall chart 350 illustrates root causes underlying an actual crop yield 352 for a particular year for a farmable region that fell short of a maximum achievable crop yield 354 for the farmable region. The difference between the actual crop yield 352 (the measured value for the agronomic output) and the maximum achievable crop yield (the desired value for the agronomic output) is due to several root causes, shown as boxes on the waterfall chart 350. The height of each box correlates to the magnitude of the effect of the root cause for that box on the reduction in crop yield.

Some of the root causes are endogenous factors 356 that were out of the control of a farm agent associated with the farmable region. Even under ideal management, the crop yield for the particular year would still have fallen short of the maximum achievable crop yield 354 due to the endogenous factors 356. This reduced crop yield that accounts for endogenous factors 358 is referred to as a predicted yield 358. In the example of FIG. 14, endogenous factors 356 include temperature, precipitation, and insects. The crop yield impacted by only endogenous factors 356 is referred to as a predicted yield 358. Other root causes are exogenous factors 360 that are primarily under the control of the farm agent. In the example of FIG. 14, exogenous factors 360 include a nitrogen level in the soil, the choice of crop variety, and the quantity of plants in the field. The effect of the exogenous factors 360 causes the predicted yield 358 to be reduced further to the level of the actual yield 352.

The depiction of endogenous and exogenous root causes in a graphical form, such as in the form of a waterfall chart, enables visualization of the reasons why a target performance may not have been achieved from a farmable region. The visualization also enables visualization of which reasons were under the control of a farm agent and which reasons were environmental or otherwise outside the control of the farm agent. This information can be useful, e.g., in evaluating the performance of the farm agent.

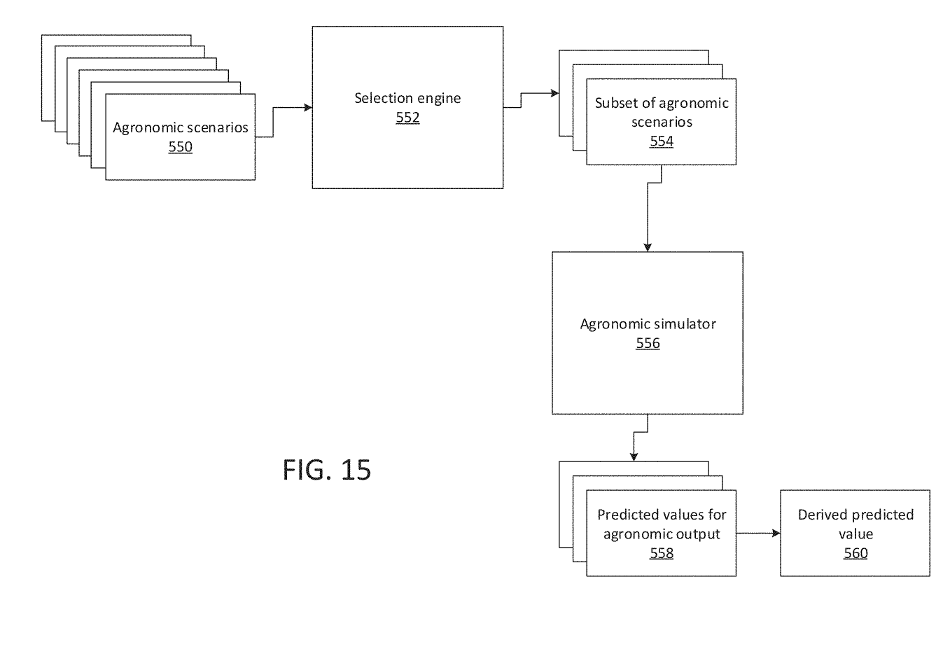

Referring to FIG. 15, in some examples, multiple agronomic scenarios 550 for a farmable region can be processed by a selection engine 552 that selects a subset 554 of the multiple agronomic scenarios to be provided as input into an agronomic simulator 556. The multiple agronomic scenarios can be measured agronomic scenarios, e.g., measured values for agronomic inputs for a current or past growing season. The multiple agronomic scenarios can be hypothetical agronomic scenarios, e.g., hypothetical weather scenarios generated by a stochastic weather generator or hypothetical values for other agronomic inputs. The subset 554 of the multiple agronomic scenarios can be selected based on values for each of one or more agronomic inputs for the agronomic scenarios.

For each agronomic scenario of the subset 554, the agronomic simulator 556 generates a predicted value 558 for an agronomic output. In some examples, the predicted values 558 for the agronomic scenarios of the subset 556 can be combined into a derived predicted value 560. The derived predicted value can be determined based on the multiple predicted values 558. For instance, the derived predicted value 560 can be the sum of the predicted values 558, the average of the predicted values 558, or otherwise based on the predicted values 558. The selection of agronomic scenarios based on values for a particular agronomic input can be useful in determining the effect of that agronomic input on the value for the resulting agronomic output.

The multiple agronomic scenarios 550 can each have one or more values for each agronomic input. For instance, the multiple agronomic scenarios 550 can each have a single value for an agronomic input related to soil conditions, such as a sandiness of the soil; and can each have multiple values for an agronomic input related to weather conditions, such as multiple values for the average temperature on consecutive days.

In some examples, to select the subset 554 based on values for a particular agronomic input, the selection engine 552 generates a profile of the values for the particular agronomic input across the multiple agronomic scenarios 550. A profile of a set of values is a description of the values. In some examples, the profile can identify a maximum value or average value, a minimum value or average value, a characteristic of a distribution of the values or average values (e.g., a standard deviation of the distribution), a most frequent value, a characteristic of a variability of the multiple values for each of the agronomic scenarios (e.g., a maximum variability, a minimum variability, an average variability, or another characteristic), or another feature of the values for the particular agronomic input across the multiple agronomic scenarios. The selection engine 552 can then identify the agronomic scenarios to be selected for the subset 554 based on the profile of the values for the particular agronomic input.

Selecting the subset 554 of agronomic scenarios based on values for an agronomic input can provide information that can be useful in evaluating the robustness of a crop variety or a farming practice to extreme values for the agronomic input, such as extreme temperatures, drought or unusually wet conditions, extreme soil conditions (e.g., sandy soil or soil with high clay content), or other extremes. By robustness, we mean the degree to which an agronomic output is affected by extreme values of an agronomic input. Selecting the subset 554 based on values for an agronomic input can also be useful in evaluating the sensitivity of a crop variety or farming practice to variability in an agronomic input, such as unusually large temperature swings, precipitation concentrated during a particular phase of plant growth, or other types of variability. By sensitivity, we mean the degree to which an agronomic output is affected by variability in values of an agronomic input.

In some examples, the agronomic scenarios selected for the subset can be those agronomic scenarios having extreme values for a particular agronomic input, such as values or average values in a top or bottom percentile (e.g., the top or bottom 5%, 10%, 20%, 25%, or another percentile) of the values for the particular agronomic input across all of the multiple agronomic scenarios. In one example, to determine the robustness of a particular crop variety to sandy soil, those agronomic scenarios having a measure of sandiness in the top 10% across all of the multiple agronomic scenarios are selected for the subset 554. The resulting predicted values 558 for an agronomic output (e.g., canopy area) for the crop variety based on the “sandiest” subset 554 of the multiple agronomic scenarios will thus provide an indication of the ability of the crop variety to grow in sandy environments. In another example, to determine the robustness of a farmable region to drought conditions, those agronomic scenarios having an amount of precipitation in the bottom 20% across all of the multiple agronomic scenarios are selected for the subset 554. The resulting predicted values 558 for an agronomic output (e.g., crop yield) for the farmable region will provide an indication of the effect of a drought on crop yield for that farmable region.

In some examples, the agronomic scenarios selected for the subset 554 can be those agronomic scenarios having the greatest variability (e.g., the least homogeneity) in the values for a particular agronomic input, such as a variability in the top 5%, 10%, 20%, 25%, or another percentile, across all of the multiple agronomic scenarios. In a specific example, to determine the sensitivity of a crop variety to temperature variability, the five agronomic scenarios having the most variability in temperature across all of the multiple agronomic scenarios are selected for the subset 554. The resulting predicted values 558 for an agronomic output (e.g., crop yield) will provide an indication of the sensitivity of crop yield to extreme variations in temperature.

In some examples, the agronomic scenarios can be selected for the subset 554 based on derived values determined from values for multiple agronomic inputs. For instance, agronomic scenarios can be selected for the subset 554 based on a combination of temperature and precipitation values. In some examples, the agronomic scenarios can be selected for the subset 554 based on other criteria, such as temporal criteria. For instance, agronomic scenarios having certain characteristics at certain times can be selected, such as agronomic scenarios having maximum or minimum precipitation during the tasseling phase of plant growth, agronomic scenarios having a maximum or minimum number of growing degree units (GDU) accumulated by a fixed calendar date, or another characteristic.

In a specific example, the robustness or sensitivity of a crop variety can be evaluated, e.g., as part of a research or development project. For instance, a new crop variety having a particular plant characteristic (e.g., a feature or quality of the plant) can be evaluated to quantify how the crop variety responds to various weather or soil conditions or to quantify a yield advantage conferred by the new crop variety under certain conditions.

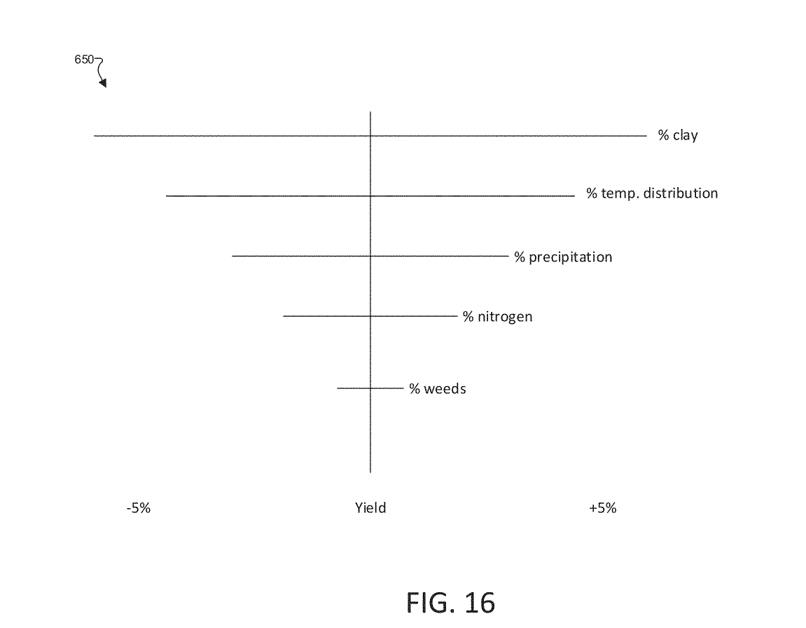

In some examples, data indicative of the sensitivity or robustness of an agronomic output to extremes or variations in values for an agronomic input can be displayed graphically. Referring to FIG. 16, in an example, a tornado chart 650 graphically depicts the effect of each of multiple agronomic inputs (clay content of the soil, temperature variability, precipitation, nitrogen content of the soil, and weed growth) on an agronomic output (crop yield). The values for each agronomic input are varied by a set percentage (e.g., +/−10% around an average value). The effect of the variation for each agronomic input is displayed as a horizontal line, the length of which corresponds to the magnitude of the effect. For instance, in the example of FIG. 16, a 10% increase in clay content of the soil causes a 5% change in crop yield, while a 10% increase in weed growth causes only a 1% change in crop yield.

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

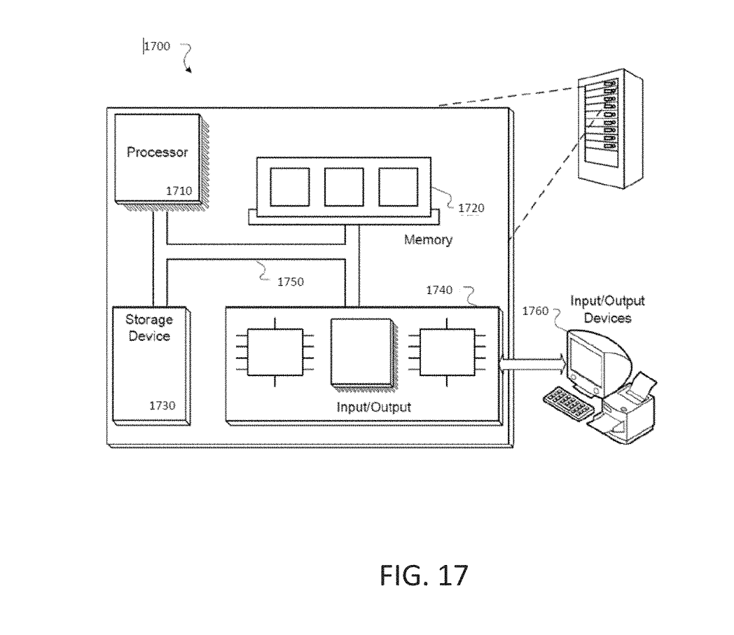

FIG. 17 is a block diagram of an example computer system 1700 that may be used in implementing the technology described in this document. General-purpose computers, network appliances, mobile devices, or other electronic systems may also include at least portions of the system 1700. The system 1700 includes a processor 1710, a memory 1720, a storage device 1730, and an input/output device 1740. Each of the components 1710, 1720, 1730, and 1740 may be interconnected, for example, using a system bus 1750. The processor 1710 is capable of processing instructions for execution within the system 1700. In some implementations, the processor 1710 is a single-threaded processor. In some implementations, the processor 1710 is a multi-threaded processor. The processor 1710 is capable of processing instructions stored in the memory 1720 or on the storage device 1730.

The memory 1720 stores information within the system 1700. In some implementations, the memory 1720 is a non-transitory computer-readable medium. In some implementations, the memory 1720 is a volatile memory unit. In some implementations, the memory 1720 is a nonvolatile memory unit.

The storage device 1730 is capable of providing mass storage for the system 1700. In some implementations, the storage device 1730 is a non-transitory computer-readable medium. In various different implementations, the storage device 1730 may include, for example, a hard disk device, an optical disk device, a solid-date drive, a flash drive, or some other large capacity storage device. For example, the storage device may store long-term data (e.g., database data, file system data, etc.). The input/output device 1740 provides input/output operations for the system 1700. In some implementations, the input/output device 1740 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1730 may be implemented in a distributed way over a network, for example a server farm or a set of widely distributed servers, or may be implemented in a single computing device.

Although an example processing system has been described in FIG. 17, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method comprising:
obtaining data indicative of multiple agronomic scenarios, the data for each agronomic scenario including a hypothetical value for each of one or more agronomic inputs, in which the data for each of the agronomic scenarios is distinct from the data for each other one of the agronomic scenarios;
for each of the multiple agronomic scenarios: predicting a predicted value for an agronomic output of a farmable region based on (i) the hypothetical value for each of the one or more agronomic inputs for the agronomic scenario and (ii) a measured value for each of at least one agronomic input of the farmable region; and
generating a distribution of the predicted values for the agronomic output across the multiple agronomic scenarios.

2. The method of claim 1, comprising generating the hypothetical values for at least one of the multiple agronomic scenarios.

3. The method of claim 1, comprising determining a characterization of the farmable region based on the distribution of the predicted values for the agronomic output across the multiple agronomic scenarios.

4. The method of claim 3, in which determining the characterization comprises determining a characterization of risk associated with the farmable region.

5. The method of claim 4, comprising determining the characterization of risk based on a standard deviation of the distribution of the predicted values for the agronomic output.

6. The method of claim 4, comprising enabling determination of an insurance policy for the farmable region based on the characterization of risk associated with the farmable region.

7. The method of claim 6, comprising assigning the farmable region to an insurance category based on the characterization of risk associated with the farmable region, and in which the determination of the insurance policy is based on the insurance category.

8. The method of claim 1, comprising:
identifying one of the predicted values for the agronomic output as a desired value; and
determining a characterization of the farmable region based on the desired value for the agronomic output.

9. The method of claim 8, in which determining the characterization comprises:
determining one or more of an expected profit associated with the farmable region, a net present value of the farmable region, and a valuation of the farmable region, and/or identifying a value for each of one or more agronomic inputs that, when applied to the farmable region, cause a value within a predetermined range of the desired value for the agronomic output to be achieved.

10. The method of claim 8, in which identifying one of the predicted values as a desired value comprises identifying the maximum or minimum predicted value as the desired value.

11. The method of claim 1, comprising:
obtaining a measured value for each of the one or more agronomic inputs of each of multiple farmable regions;
for each of the multiple agronomic scenarios and for each of the multiple farmable regions: predicting a value for the agronomic output of the farmable region based on (i) the hypothetical value for each of the one or more agronomic inputs for the agronomic scenario and (ii) the measured value for each of the one or more agronomic inputs of the farmable region; and
determining a derived predicted value for the agronomic output for the multiple farmable regions for each of the multiple agronomic scenarios.

12. The method of claim 11, comprising determining a characterization of the multiple farmable regions based on the derived predicted value for the agronomic output.

13. The method of claim 12, in which the agronomic output comprises a crop yield, and in which determining the derived predicted value comprises determining a total predicted crop yield for the multiple farmable regions.

14. The method of claim 13, in which determining the characterization comprises determining a commodity forecast based on the predicted total crop yield.

15. The method of claim 1, in which predicting the predicted value for the agronomic output comprises operating an agronomic simulator previously calibrated based on one or more measured agronomic inputs or one or more measured agronomic outputs of the farmable region.

16. The method of claim 1, in which predicting the predicted value for the agronomic output comprises predicting the value for the agronomic output based on data indicative of weed growth in the farmable region, data indicative of plant hypoxia in the farmable region, data indicative of insect activity in the farmable region, data indicative of disease in the farmable region, and/or data indicative of a plant growth cycle for plants in the farmable region.

17. A method comprising:
obtaining a predicted value for an agronomic output of a farmable region for each of multiple agronomic scenarios, each agronomic scenario associated with data including a hypothetical value for each of one or more agronomic inputs, in which the data for each of the agronomic scenarios is distinct from the data for each other one of the agronomic scenarios; and
identifying a desired predicted value for the agronomic output across the multiple agronomic scenarios.

18. The method of claim 17, in which identifying the desired predicted value for the agronomic output comprises identifying a maximum predicted value, the agronomic output comprises a crop yield, and the desired predicted value comprises a maximum predicted crop yield.

19. The method of claim 17, comprising identifying a value for each of one or more of the agronomic inputs that, when applied to the farmable region, causes a value within a predetermined range of the desired predicted value for the agronomic output to be achieved.

20. The method of claim 17, comprising comparing the desired predicted value for the agronomic output to one or more historical values for the agronomic output for the farmable region.

21. The method of claim 20, comprising enabling determination of an insurance policy for the farmable region or for a farm agent associated with the farmable region based on the comparison.

22. The method of claim 21, in which enabling determination of the insurance policy comprises one or more of enabling determination of whether to issue the insurance policy, enabling determination of a price of the insurance policy, and enabling determination of a risk associated with the insurance policy.

23. A method comprising:
obtaining data indicative of a measured value for an agronomic output of a farmable region for a period of time and a measured value for each of one or more agronomic inputs of the farmable region for the period of time;
determining a hypothetical value for the agronomic output of the farmable region for the period of time, the hypothetical value for the agronomic output associated with a hypothetical value for each of the one or more agronomic inputs;
identifying one or more of the agronomic inputs for which the measured value for the agronomic input differs from the hypothetical value for the agronomic input; and
generating data for a graphical representation of the hypothetical value for the agronomic output, the measured value for the agronomic output, and the identified agronomic inputs.

24. The method of claim 23, in which determining the hypothetical value for the agronomic output of the farmable region includes:
obtaining data indicative of a predicted value for the agronomic output of the farmable region for each of multiple agronomic scenarios, in which each agronomic scenario is associated with data including a hypothetical value for each of one or more agronomic inputs, in which the data for one of the agronomic scenarios is distinct from the data for each other one of the agronomic scenarios; and
identifying one of the predicted values for the agronomic output as the hypothetical value for the agronomic output.

25. The method of claim 23, comprising calculating a difference between the hypothetical value for the agronomic output of the farmable region and the measured value for the agronomic output of the farmable region for the period of time, in which identifying one or more of the agronomic inputs comprises identifying an agronomic input for which the difference between the measured value and the hypothetical value for the agronomic input affects the difference between the hypothetical value and the measured value for the agronomic output.

26. The method of claim 25, comprising:
comprising calculating a difference between the hypothetical value for the agronomic output of the farmable region and the measured value for the agronomic output of the farmable region for the period of time; and
identifying a value for each of one or more of the identified agronomic inputs that, when applied to the farmable region, is predicted to cause the difference between the measured value and the hypothetical value for the agronomic output to be decreased.

27. A method comprising:
obtaining data indicative of multiple agronomic scenarios, the data for each agronomic scenario including a value for each of one or more agronomic inputs, in which the data for each of the agronomic scenarios is distinct from the data for each other one of the agronomic scenarios;
selecting one or more of the multiple agronomic scenarios based on the value for a particular one of the agronomic inputs for each of the agronomic scenarios; and
for each of the selected agronomic scenarios: predicting a value for an agronomic output of a farmable region based on the value for each of the one or more agronomic inputs for the selected agronomic scenario.

28. The method of claim 27, in which selecting one or more of the agronomic scenarios comprises: selecting the agronomic scenarios having a maximum value or a minimum value for the particular one of the agronomic inputs, or selecting the agronomic scenarios based on an entropy associated with the values for the agronomic inputs included in the selected agronomic scenarios.

29. The method of claim 27, comprising:
determining a derived predicted value for the agronomic output based on the predicted value for the agronomic output for each of the selected agronomic scenarios; and
determining a sensitivity of the agronomic output to a variation in the particular one of the agronomic inputs based on the derived predicted value for the agronomic output.

30. The method of claim 27, comprising:
predicting the value for the agronomic output of the farmable region based on a value for each of one or more plant characteristics for a crop variety; and
determining a sensitivity of the crop variety to a variation in the particular one of the agronomic inputs based on the predicted values for the agronomic output.
